(19) United States
(12) Patent Application Publication
(10) Pub. No.: US 2010/0116597 A1
(43) Pub. Date: May 13, 2010

(54) ELEVATOR

(75) Inventors: Hisashi MATSUDA, Tokyo (JP); Fumio OOTOMO, Tokyo (JP); Motofumi TANAKA, Tokyo (JP); Kazuo HAYASHI, Tokyo (JP); Shinichi NODA, Tokyo (JP); Sueyoshi MIZUNO, Tokyo (JP)

Correspondence Address: FOLEY AND LARDNER LLP;SUITE 500, 3000 K STREET NW, WASHINGTON, DC, 20007, US

(73) Assignee: TOSHIBA ELEVATOR KABUSHIKI KAISHA

(21) Appl. No.: 12/613,132

(22) Filed: Nov. 5, 2009

(30) Foreign Application Priority Data
Nov. 7, 2008 (JP) 2008-287027
May 18, 2009 (JP) 2009-120311

(51) Int. Cl. B66B 11/02; B66B 1/00; B66B 7/00; B66B 9/00

(52) U.S. Cl. 187/401; 187/404

(57) ABSTRACT

An elevator includes a car that ascends and descends in an elevation path, and at least one airflow generation device that is set on a surface of a top end part of at least one of upper and lower end parts of the car, the surface facing a platform of the elevation path, and suppresses a separation flow generated at the top end of the car during running, thereby to generate an airflow for rectifying an airflow flowing into a front side of the car.

### CROSS-REFERENCE TO RELATED APPLICATIONS

This application is based upon and claims the benefit of priority from prior Japanese Patent Applications No. 2008-287027, filed Nov. 7, 2008; and No. 2009-120311, filed May 18, 2009, the entire contents of both of which are incorporated herein by reference.

### BACKGROUND OF THE INVENTION

1. Field of the Invention

The present invention relates to an elevator provided with a flow generation device.

2. Description of the Related Art

As buildings have been converted into high-rises, elevators built in such buildings have been developed to achieve higher speeds. However, as a rated speed of an elevator exceeds 400 m/min, aerodynamic noise caused by airflows around an elevator car becomes a problem (for example, see JSME journals (series B), Vol. 59, No. 564 (1993-8), Paper No. 92-1876).

The rated speed of an elevator is defined as “referring to a maximum speed when an elevator ascends with a live load acting on a car” under the Building Standards Law. Where elevators are classified depending on speeds, elevators having a rated speed of 45 m/min are classified into a category of “low speed”; elevators having a rated speed of 60 to 105 m/min are classified into a category of “middle speed”; elevators having a rated speed of 120 m/min or higher are classified into a category of “high speed”; and elevators having a rated speed of 360 m/min are classified into a category of “ultra high speed”.

Hereinafter, elevators classified into the category “ultra high speed” or “high speed” will be referred to as “high speed elevators”.

As a solution to reduce aerodynamic noise of high speed elevators, there is a method for mounting a wind rectification cover on a top end of a car (for example, see Jpn. Pat. Appln. KOKAI Publication No. 4-333486). Further in order to cope with higher speed elevators, a technique of attaching a rectification spoiler onto a rectification cover has been developed (for example, see Jpn. Pat. Appln. KOKAI Publication No. 2005-162496). The technique of the rectification spoiler has been introduced into the world's highest speed elevator (for example, see World's Highest Speed 1010 m/min Elevator, Toshiba review, vol. 57, No. 6 (2002)).

However, in case of elevators which run in narrow elevation paths, narrow parts such as hall sills exist, in elevation paths, respectively corresponding to floors to which the elevators ascend and descend. When a car passes such a narrow part, local aerodynamic noise (buff sound) is generated and gives rise to a problem that passengers who are in the car or are waiting on a platform feel uncomfortable.

As a result of observing such aerodynamic noise during running, it has been known that large noise is generated when a top end part of a rectification cover of a car is about to pass narrow parts in an elevation path (for example, see reduction of aerodynamic noise of ultra high speed elevators, JSME technical lecture meeting, No. 97-76 (1997)).

Usually, an elevator runs balanced between a car body and a counter weight having an equal weight to the car body. Therefore, when the counter weight and the car body pass each other at a high speed around an intermediate floor, loud aerodynamic noise is generated around the car as in the case where a car passes a narrow part.

For aerodynamic noise generated when passing a narrow part, attaching a rectification spoiler according to the foregoing Jpn. Pat. Appln. KOKAI Publication. No. 2005-162496 is effective. Particularly when a wedge-shaped rectification spoiler is attached, airflows from the rectification spoiler toward the front side of the car are rectified regardless of whether the car is passing a narrow part or not. Accordingly, it is considered that pressure fluctuation is suppressed and aerodynamic noise is reduced.

With respect to effect of interference with a counter weight, a nose shape of the counter weight is devised. The effect of interference is considered to be reduced by dividing the counter weight into plural pieces.

However, structural modifications as described above require increased costs and are sometimes inapplicable due to limitations of size of an elevation path. In the present circumstances in which elevators are getting higher speeds and comfortableness is required more and more, there is a case that aerodynamic noise can not effectively be reduced by only such structural modifications.

### BRIEF SUMMARY OF THE INVENTION

The present invention has been made in view of the above problems and has as its object to provide an elevator capable of effectively reducing aerodynamic noise occurring when an elevator car passes a narrow part of an elevation path and/or when the elevator car and a counter weight pass each other.

According to an aspect of the present invention, there is provided an elevator comprising: a car that ascends and descends in an elevation path; and at least one airflow generation device that is set on a surface of a top end part of at least one of upper and lower end parts of the car, the surface facing a platform of the elevation path, and suppresses a separation flow generated at the top end of the car during running, thereby to generate an airflow for rectifying an airflow flowing into a front side of the car.

According to another aspect of the present invention, there is provided an elevator comprising: an elevator comprising: a car that ascends and descends in an elevation path; a counter weight that ascends and descends like a draw bucket in association with the car; and at least one airflow generation device that is set on a top end part of at least one of upper and lower end parts of the counter weight, in a side of the top end part facing the car, and suppresses a separation flow generated at the top end of the counter weight during running, thereby to generate an airflow for rectifying an airflow flowing into a front side of the counter weight.

According to another aspect of the present invention, there is provided an elevator comprising: an elevator comprising: a car that ascends and descends in an elevation path; a counter weight that ascends and descends like a draw bucket in association with the car; at least one first airflow generation device that is set on a surface of a top end part of at least one of upper and lower end parts of the car, the surface facing a platform of the elevation path, and suppresses a separation flow generated at the top end of the car during running, thereby to generate an airflow for rectifying an airflow flowing into a front side of the car; and at least one second airflow generation device that is set on a top end part of at least one of upper and lower end parts of the counter weight, in a side facing the car, and suppresses a separation flow generated at the top end part of the counter weight during running, thereby to generate an airflow for rectifying an airflow flowing into a front side of the counter weight.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view illustrating an airflow generation device using discharge plasma;

FIG. 2 is a graph representing an example of change in speed of exciting flows generated by the airflow generation device in FIG. 1;

FIG. 3 is a view illustrating an airflow generation device using discharge plasma;

FIG. 4 is a graph representing an example of change in speed of exciting flows generated by the airflow generation device in FIG. 3;

FIG. 5 is also a graph representing an example of change in speed of exciting flows generated by the airflow generation device in FIG. 3;

FIGS. 6A and 6B are views illustrating a configuration of an elevator according to the first embodiment of the invention wherein FIG. 6A is a side view of a car running in an elevation path and FIG. 6B is a front view of the car observed in a direction A;

FIGS. 7A and 7B are views illustrating states of airflows occurring at a top end part of a rectification cover wherein FIG. 7A illustrates a state of plasma OFF and FIG. 7B illustrates a state of plasma ON;

FIG. 8 represents a result of measuring pressure fluctuation in case where a car is made run at a predetermined speed in an elevation path in a scale model experiment according to the embodiment;

FIG. 9 is a block diagram illustrating a configuration of a control system for airflow generation devices in the embodiment;

FIG. 10 is a flowchart representing drive control of the airflow generation devices during running of the car of the elevator according to the embodiment;

FIG. 11 is a view illustrating a configuration of a car according to the second embodiment of the invention;

FIGS. 12A and 12B are views illustrating a configuration of an elevator according to the third embodiment of the invention wherein FIG. 12A is a side view of a car running in an elevation path and FIG. 12B is a front view of the car observed in a direction A;

FIG. 13 illustrates a configuration of a car of an elevator according to the fourth embodiment of the invention;

FIG. 14 is a side view illustrating configurations of a car and a counter weight of an elevator according to the fifth embodiment of the invention;

FIG. 15 is a view illustrating a configuration of the counter weight of the elevator according to the embodiment;

FIG. 16 is a view illustrating a configuration of a counter weight of an elevator according to the sixth embodiment of the invention;

FIG. 17 is a view illustrating a configuration of a counter weight of an elevator according to the seventh embodiment of the invention;

FIG. 18 is a view illustrating a configuration of a counter weight of an elevator according to the eighth embodiment of the invention;

FIG. 19 is a side view illustrating configurations of a car and a counter weight of an elevator according to the ninth embodiment of the invention;

FIGS. 20A and 20B are views illustrating a configuration of an elevator according to the tenth embodiment of the invention wherein FIG. 20A is a side view of a car running in an elevation path and FIG. 20B is a front view of the car observed in a direction A;

FIGS. 21A, 21B, and 21C are views illustrating states of airflows occurring at a top end part of a fall guard plate of a car according to the embodiment wherein FIG. 21A illustrates a state of plasma OFF, FIG. 21B illustrates a state of plasma ON, and FIG. 21C illustrates a state of plasma ON on two sides;

FIG. 22 represents a result of measuring pressure fluctuation in case where the car is made run at a predetermined speed in an elevation path in a scale model experiment according to the embodiment;

FIG. 23 represents another result of measuring pressure fluctuation in case where the car is made run at a predetermined speed in an elevation path in a scale model experiment according to the embodiment;

FIG. 24 is a diagram illustrating a configuration of a synthetic jet device according to the eleventh embodiment of the invention;

FIGS. 25A and 25B are views illustrating a configuration of an elevator in case where synthetic jet devices are used as airflow generation devices in the embodiment wherein FIG. 25A is a side view of a car running in an elevation path and FIG. 25B is a front view of the car from a direction A;

FIGS. 26A and 26B are views illustrating a configuration of an elevator in case where a small fan is used as an airflow generation device according to the twelfth embodiment of the invention wherein FIG. 26A is a side view of a car running in an elevation path and FIG. 26B is a front view of the car observed in a direction A;

FIGS. 27A and 27B are views illustrating a configuration of an elevator according to the thirteenth embodiment of the invention wherein FIG. 27A is a side view of a car running in an elevation path and FIG. 27B is a front view of the car observed in a direction A;

FIG. 28 represents a result of monitoring aerodynamic noise generated during running of an elevator;

FIGS. 29A and 29B are diagrams in which airflows around a car during running of an elevator are graphically reproduced by Computational Fluid Dynamics wherein FIG. 29A graphically represents airflows when a top end part of a fall guard plate is about to pass a narrow part in an elevation path and FIG. 29B partially represents part of airflows in front of the car;

FIGS. 30A and 30B graphically represent an analysis result in case where separation flows are suppressed by airflow generation devices wherein FIG. 30A graphically represents airflows when a top end part of a fall guard plate is about to pass a narrow part in an elevation path and FIG. 30B graphically represents part of flows in front of the car;

FIG. 31 is a graph representing a relationship between running speeds of elevators and noise generated when cars pass a narrow part;

FIGS. 32A and 32B are views illustrating a configuration of an elevator according to the fourteenth embodiment of the invention wherein FIG. 32A is a side view of a car running in an elevation path and FIG. 32B is a front view of the car observed in a direction A;

FIGS. 33A and 33B are views illustrating a configuration of an elevator according to the fifteenth embodiment of the invention wherein FIG. 33A is a side view of a car running in an elevation path and FIG. 33B is a front view of the car observed in a direction A; and

FIGS. 34A and 34B are views illustrating a configuration of an elevator according to the sixteenth embodiment of the invention wherein FIG. 34A is a side view of a car running in an elevation path and FIG. 34B is a front view of the car observed in a direction A.

### DETAILED DESCRIPTION OF THE INVENTION

Hereinafter, embodiments of the present invention will be described with reference to the drawings.

The invention is to reduce aerodynamic noise by controlling flows around a car with use of an airflow generation device during running. The airflow generation device is, for example, a device which emits a two-dimensional jet flow from a fan or a device using a synthetic jet. In view of downsizing and controllability of devices, an airflow generation device using discharge plasma is considered most suitable.

Airflow generation devices using discharge plasma are described in Jpn. Pat. Appln. KOKAI Publications. No. 2007-317656 and No. 2008-1354. Only a basic configuration thereof will be described below.

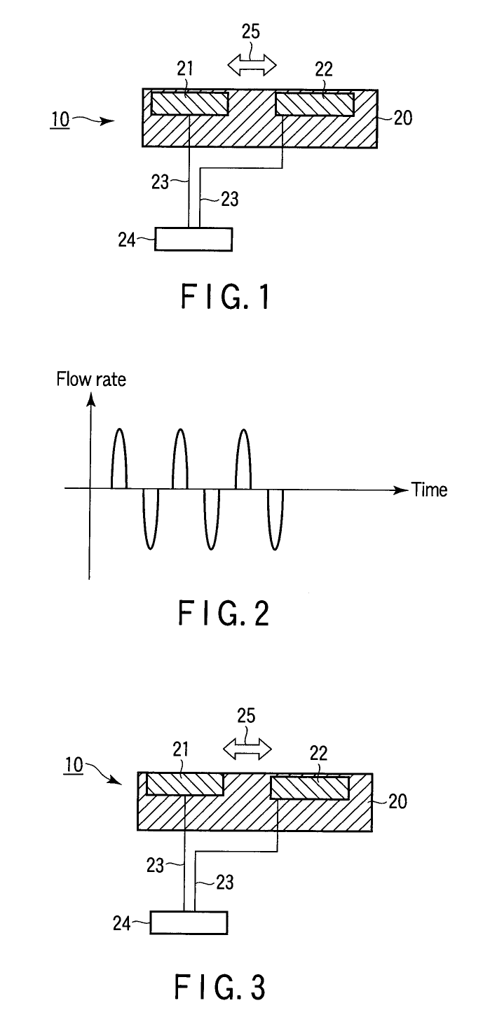

FIG. 1 is a diagram illustrating a configuration of an airflow generation device using discharge plasma.

As illustrated in FIG. 1, the airflow generation device 10 is constituted by first and second electrodes 21 and 22 embedded in a dielectric substance 20, and a discharge power supply 24 which applies a voltage between the electrodes 21 and 22 through a cable 23. The second electrode 22 and the first electrode 21 are equally distant from a surface of the dielectric substance 20, and are positioned slightly apart from each other in directions horizontal to the surface of the dielectric substance 20.

Electric insulative material such as glass, polyimide, or rubber is used as the dielectric substance 20. By using popular copper plates for the electrodes 21 and 22, the device can be configured to have a thickness of several hundred μm or less.

In a configuration as described above, a voltage is applied between the first and second electrodes 21 and 22 from the discharge power supply 24. When a potential difference reaches a constant threshold or higher, discharge takes place between the first electrode 21 and the second electrode 22, and exciting flows (airflow) 25 are generated near electrodes. The size and direction of the exciting flows 25 can be controlled by changing the voltage applied between the electrodes 21 and 22 and current-voltage characteristics such as a frequency, current waveform, and a duty ratio.

As represented in FIG. 2, the exciting flows 25 can be continuously generated by applying an alternating voltage or current between the electrodes 21 and 22. The example of FIG. 2 graphically represents a state that exciting flows toward the electrode 21 (e.g., exciting flows toward the left in FIG. 1) and toward the electrode 22 (e.g., exciting flows toward the right) are generated symmetrically. Both exciting flows have substantially equal flow rates.

Alternatively, the airflow generation device 10 can be configured as illustrated in FIG. 3.

In FIG. 3, the airflow generation device 10 is constituted by a first electrode 21, a second electrode 22, and a discharge power supply 24 which applies a voltage between the electrodes 21 and 22 through a cable 23. The first electrode 21 is exposed from the same plane as a surface of the dielectric substance 20. The second electrode 22 and the first electrode 21 are differently distant from the surface of the dielectric substance 20, and are embedded in the dielectric substance 20, shifted slightly apart from each other in directions horizontal to the surface of the dielectric substance 20. That is, the configuration of FIG. 3 differs from that of FIG. 1 in that the first electrode 21 is exposed from the same plane as the surface of the dielectric substance 20.

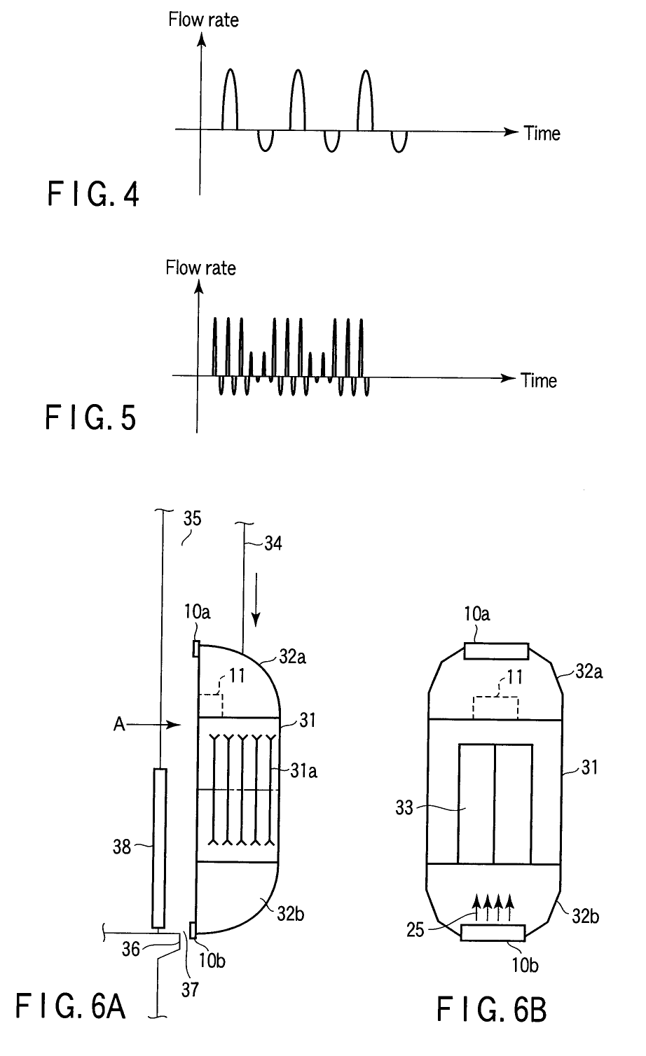

If, in a configuration as described above, an alternating voltage or current having a frequency of a predetermined value or lower is applied between the electrodes 21 and 22, exciting flows 25 can be generated, as graphed in FIG. 4, such that flowing directions of the exciting flows 25 are opposite to each other along the surface of the airflow generation device 10, which is the surface of the dielectric substance 20, and the exciting flows 25 oscillate at different flow rates in the respective flowing directions.

In the example of FIG. 4, directions of exciting flows 25 toward the electrode 22 (e.g., the exciting flow toward the right in FIG. 3) are taken to be positive. In this case, exciting flows 25 toward the electrode 21 (e.g., exciting flows toward the left in FIG. 3) and other exciting flows 25 toward the electrode 22 (e.g., exciting flows toward the right in FIG. 3) are generated and flow at respectively different flow rates.

By adjusting a voltage value to be applied, the exciting flows 25 which flow in one direction on time average can be generated, as represented in FIG. 5.

Documents cited below describe that acceleration of flows on a wing surface can be controlled by such exciting flows as described above. In addition, it has been confirmed that control of flows around a wing can be more efficiently performed by unsteadily controlling discharge.

“JSME 85-th Period Fluids Engineering Division Meeting, No. 07-16, ISSN 1348-2882, (2007), OS5-1-503”

“JSME journals (series B), Vol. 74, No. 744 (2008-8), Paper No. 08-7006”

Described next will be a specific configuration in case of applying the airflow generation device 10 to an elevator.

### First Embodiment

FIGS. 6A and 6B illustrate a configuration of an elevator according to the first embodiment of the invention. FIG. 6A is a side view of a car running in an elevation path. FIG. 6B is a front view of the car from a direction A.

The elevator according to the present embodiment includes a car 31 having a streamlined shape, which is mainly used in high speed elevators. The car 31 ascends and descends in an elevation path 35 by a rope 34 which is driven by a winder not illustrated.

In the elevation path 35, hall sills 36 are provided for platforms on respective floors. A hall door 38 is provided to be openable/closable on each hall sill 36. A car door 33 is provided to be openable/closable on a front side of the car 31. When the car 31 stops at a platform on each floor, the car door 33 opens/closes in engagement with the hall door 38.

Reference symbol 37 in the figures denotes a narrow part formed of a protrusion of a hall sill 36. When the car 31 passes the narrow part 37, local aerodynamic noise (buff sound) is generated and results in a problem that passengers in the car 31 or waiting on a platform are made feel uncomfortable.

In order to reduce such aerodynamic noise, rectification covers 32a and 32b having gently curved surfaces covering upper and lower end parts of the car 31 are attached. The rectification covers 32a and 32b have flat surfaces which face a side of the elevation path 35 facing platforms, and also have opposite surfaces which are formed to be semi-spherical. Plural grooves 31a are formed in side surfaces of the car 31.

Separately from such a structural noise reduction solution, airflow generation devices 10a and 10b using discharge plasma described above are used. The airflow generation devices 10a and 10b are attached to surfaces of top end parts of the rectification covers 32a and 32b, which face the side of the elevation path 35 facing platforms. Since the airflow generation devices 10a and 10b each can be constructed as a module based on insulative material such as ceramics, parts of such modules can be easily fixed to the rectification covers 32a and 32b by screwing or an adhesive.

The airflow generation devices 10a and 10b each have a configuration as illustrated in FIG. 1 or 3, and are driven by a drive device 11 at predetermined timings during running of the car 31.

The predetermined timings are, specifically, when the upper end part of the car 31 passes each hall sill 36 during up elevation of the car 31 and when the lower end part of the car 31 passes each hall sill 36 during down elevation of the car 31.

That is, the airflow generation device 10a provided on the rectification cover 32a is driven to generate exciting flows 25 in a descending direction of the car 31 when a top end part of the rectification cover 32a passes each hall sill 36 during an ascent of the car 31. Meanwhile, the airflow generation device 10b provided on the rectification cover 32b is driven to generate exciting flows 25 in a ascending direction of the car 31 when a top end part of the rectification cover 32b passes each hall sill 36 during a descent of the car 31.

Assuming that the car 31 is descending now, operation and effects of the airflow generation device 10b will be described below.

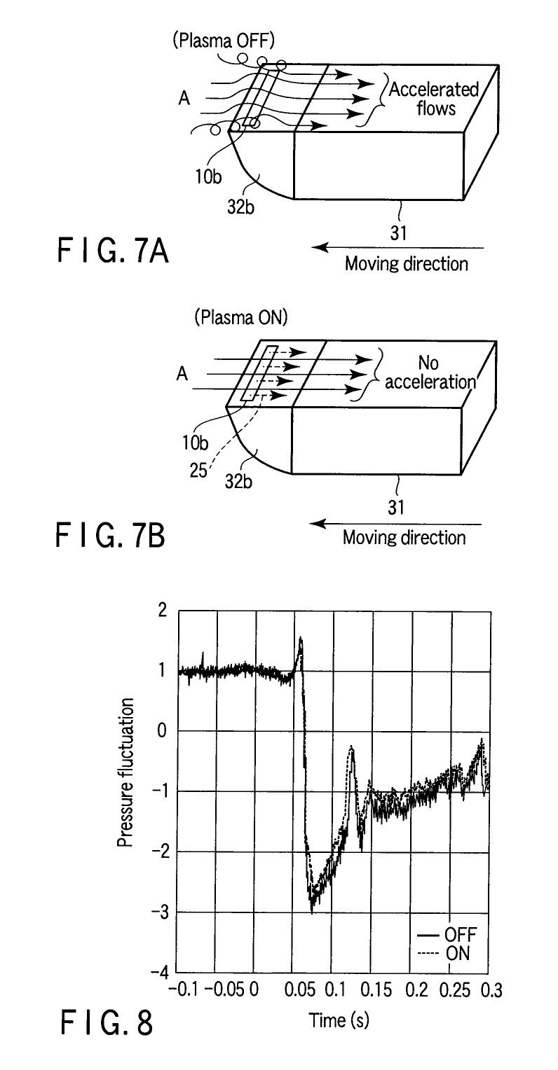

FIGS. 7A and 7B are views illustrating states of airflows occurring at a top end part of a rectification cover. FIG. 7A illustrates a state of plasma OFF and FIG. 7B illustrates a state of plasma ON.

As illustrated in FIG. 7A, when the top end part of the rectification cover 32b is just passing a narrow part 37 such as a hall sill of the elevation path 35 during a descent of the car 31, air dammed by the top end part of the rectification cover 32b abruptly flows into the front side of the car 31, and local accelerated flows occur in front of the car door 33. The accelerated flows cause large pressure fluctuation, which results in occurrence of aerodynamic noise.

As illustrated in FIG. 7B, if exciting flows 25 are generated in a direction (i.e., ascending direction) opposite to a moving direction of the car 31 from the airflow generation device 10b during a descent of the car 31, a phenomenon of damming at the top end part of the rectification cover 32b is suppressed so that airflows flowing into the front side of the car 31 from the top end part can be rectified. Accordingly, pressure fluctuation is suppressed and aerodynamic noise can be suppressed as a result.

FIG. 8 represents a result of measuring pressure fluctuation in case where a car is made run at a predetermined speed in an elevation path in a scale model experiment. The horizontal axis represents time and the vertical axis represents a fluctuation value relative to a pressure before the car passes. In the figure, a continuous line represents a characteristic of plasma OFF, and a broken line represents a characteristic of plasma ON.

Abrupt pressure fluctuation occurs when the top end part of the car 31 passes a narrow part 37 on the elevation path 35. However, if exciting flows 25 are generated in advance in a direction opposite to the moving direction of the car 31 by setting plasma ON, pressure fluctuation thereof is suppressed and aerodynamic noise is reduced accordingly.

The above result also applies to an ascent of the car 31.

That is, airflows flowing from the top end part of the rectification cover 32a can be rectified by generating exciting flows 25 in a direction (i.e., descending direction) opposite to the moving direction of the car 31 from the airflow generation device 10a attached to the top end part of the rectification cover 32a when the top end part of the rectification cover 32a is about to pass narrow parts 37 such as hall sills 36 on the elevation path 35. Pressure fluctuation can be thereby suppressed, and aerodynamic noise can be suppressed as a result.

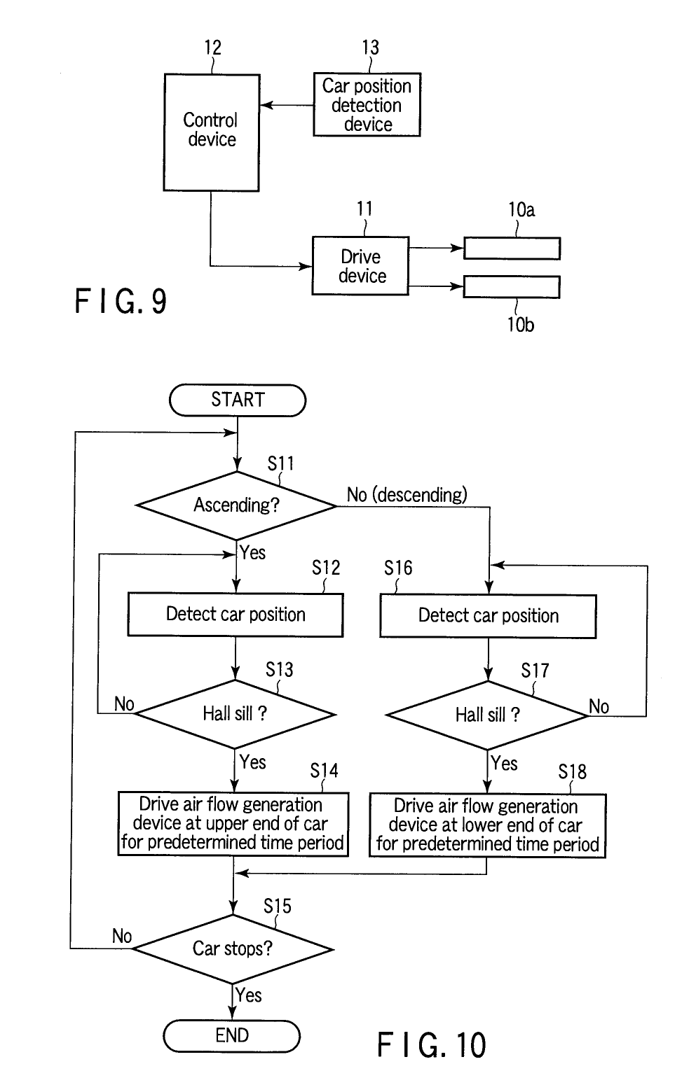

Next, a method for driving the airflow generation devices 10a and 10b will be described with reference to FIGS. 9 and 10.

FIG. 9 is a block diagram illustrating a configuration of a control system for the airflow generation devices.

A drive device 11 is set on the car 31 and includes a battery for supplying electric power required to drive the airflow generation devices 10a and 10b. The drive device 11 supplies electric power to the airflow generation devices 10a and 10b to drive these devices, based on a drive signal output from a control device 12.

The control device 12 is set in a machine room in a building. The control device 12 is constituted by a computer mounting a CPU, a ROM, a RAM, etc. The control device 12 performs operation control of the entire elevator by staring up a predetermined program. In this case, the control device 12 performs drive control of the airflow generation devices 10a and 10b. The control device 12 and the drive device 11 on the car 31 are electrically connected by a tail code or wirelessly.

A car position detection device 13 detects a position of the car 31 running in the elevation path 35 on real time, based on a pulse signal which is output from a pulse encoder (not illustrated) in synchronism with rotation of a winder.

FIG. 10 is a flowchart expressing drive control of the airflow generation devices during running of the car.

The car 31 is assumed now to be moving at a predetermined speed in an ascending direction (Yes in a step S11). The control device 12 detects a position of the car 31, based on a position signal output from the car position detection device 13 (step S12). Further, the control device 12 causes the drive device 11 to drive the airflow generation device 10a for a predetermined time period (step S14) immediately before the top end part of the rectification cover 32a attached to the upper end part of the car 31 passes a hall sill 36 (Yes in a step S13).

The foregoing predetermined time period refers to time required until the top end part of the car 31 passes throughout a hall sill 36. The predetermined time period is about 0.3 to 0.5 seconds though this time period varies depends on speeds of the car 31.

Otherwise, when the car 31 is moving at a predetermined speed in a descending direction (No in the step S11), the control device 12 also detects the position of the car 31, based on the position signal output from the car position detection device 13 (step S16). Further, the control device 12 causes the drive device 11 to drive the airflow generation device 10b for the predetermined time period (step S18) immediately before the top end part of the rectification cover 32b attached to the lower end part of the car 31 passes the hall sill 36 (Yes in a step S17).

Thus, in the elevator, driving of the airflow generation device 10a is controlled at the timing when the top end part of the rectification cover 32a passes a hall sill 36 during an ascent. On the other side, driving of the airflow generation device 10b is controlled at the timing when the top end part of the rectification cover 32a passes a hall sill 36 during a descent. Pressure fluctuation caused when the car 31 passes a hall sill 36 is steadily suppressed by plasma airflows, and accordingly, aerodynamic noise can be reduced.

Meanwhile, developments have been started in use of airflow control utilizing discharge plasma in the field of aircrafts. However, this airflow control is usually used to reduce air resistance during movement. In general cases, plasma is always ON.

In contrast, in case of the present elevator, the car 31 moves at a high speed in a limited space of the elevation path 35, unlike in case of moving objects such as aircrafts. At hall sills 35 in the middle of the elevation path 35, aerodynamic noise occurs due to abrupt pressure fluctuation. Therefore, in order to reduce such aerodynamic noise, drive control particular to elevators is needed, e.g., plasma needs to be switched on at a predetermined timing while detecting the position of a car along an elevation path, as has been described referring to FIG. 10. Further, controlling plasma to be switched on/off is also recommended from a viewpoint of energy saving.

Only several watt of electric power is required to generate plasma exciting flows. Therefore, this drive power can be easily fed from the car 31. Since the size of the drive device 11 may therefore be small, the drive device 11 can be easily set on the car 31.

The first embodiment described above assumes a car 31 attached with rectification covers 32a and 32b. If neither the rectification cover 32a nor 32b is attached, the airflow generation devices 10a and 10b may be set on a surface of the car 31 facing platforms at upper and lower end parts of the car 31. Then, the same effects as described above can be obtained.

The airflow generation device 10a or 10b may be set on a surface of the car 31 facing platforms at least one of the upper and lower end parts of the car 31.

### Second Embodiment

Next, the second embodiment of the present invention will be described below.

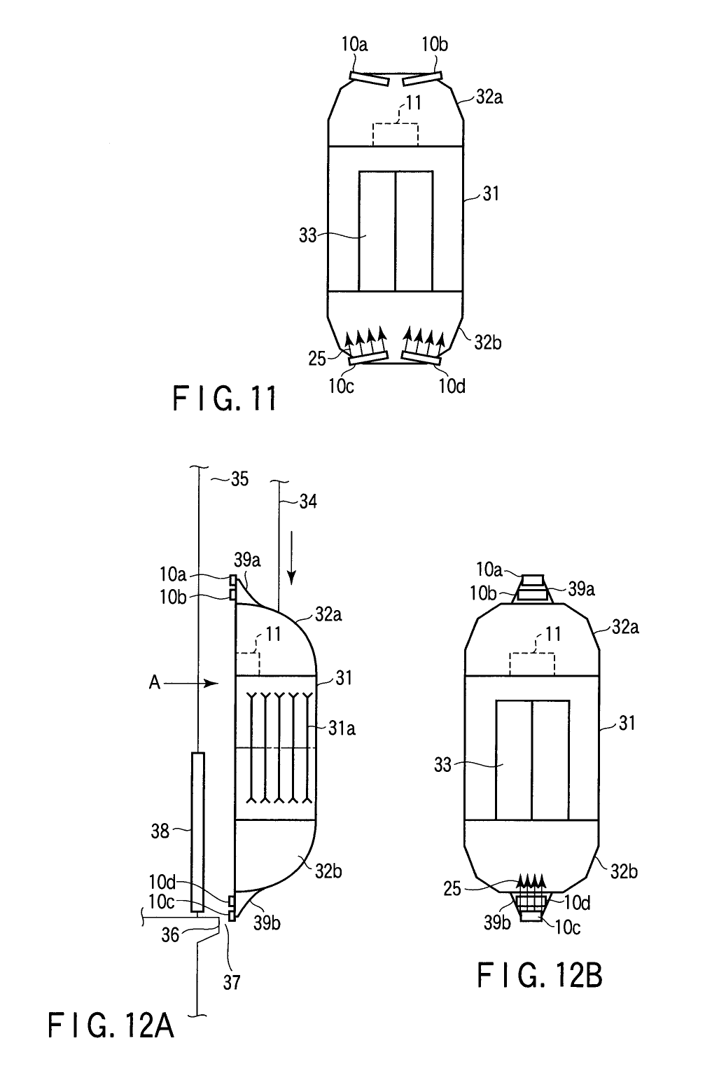

FIG. 11 illustrates a configuration of a car of an elevator according to the second embodiment of the invention. As in the first embodiment, a rectification cover 32a is attached to an upper end part of a car 31, and a rectification cover 32b is attached to a lower end part of the car 31.

In the second embodiment, two airflow generation devices 10a and 10b are provided on a surface of a top end part of the rectification cover 32a, which faces a side of an elevation path 35 facing platforms. Similarly, two airflow generation devices 10c and 10d are provided on a surface of a top end part of the rectification cover 32b, which faces the side of the elevation path 35 facing platforms.

The airflow generation devices 10a, 10b, 10c, and 10d each have a configuration as illustrated in FIG. 1 or 3, and are driven at predetermined timings by a drive device 11 during running of the car 31.

The predetermined timings are, specifically, when the top end part of the rectification cover 32a passes each hall sill 36 during an ascent of the car 31 and when the top end part of the rectification cover 32b passes each hall sill 36 during a descent of the car 31.

The drive device 11 is set on the car 31. A control device 12 illustrated in FIG. 9 detects a position of the car 31, based on a position signal output from a car position detection device 13. When the car 31 passes a predetermined position, the control device 12 controls driving of the airflow generation devices 10a, 10b, 10c, and 10d by the drive device 11.

In the example of FIG. 11, the airflow generation devices 10a and 10b are simultaneously driven to generate exciting flows 25 in a descending direction of the car 31 when the top end part of the rectification cover 32a passes each hall sill 36 during an ascent of the car 31. On the other side, the airflow generation devices 10c and 10d are simultaneously driven to generate exciting flows 25 in an ascending direction of the car 31 when the top end part of the rectification cover 32b passes each hall sill 36 during a descent of the car 31.

Thus, in the car 31 with rectification covers, the airflow generation devices 10a and 10b are provided on the top end part of the rectification cover 32a, and the airflow generation devices 10c and 10d are provided on the top end part of the rectification cover 32b. In this manner, when the top end parts of the rectification covers 32a and 32b are about to pass narrow parts 37 such as hall sills 36, airflows flowing into the front side of the car 31 can be rectified. As a result, pressure fluctuation caused by the narrow parts 37 during high speed running can be suppressed, and generation of aerodynamic noise can accordingly be suppressed.

The airflow generation devices 10a and 10b as well as the airflow generation devices 10c and 10d may be arranged tandem in ascending and descending directions on the top end parts of the rectification covers 32a and 32b, respectively. Alternatively, as illustrated in FIG. 11, the airflow generation devices 10a and 10b as well as the airflow generation devices 10c and 10d may be tilted in a substantial inverted V-shape so that air around the top end parts of the rectification covers 32a and 32b smoothly flows toward sides.

The term of “arranged tandem” is intended to mean, in the example of airflow generation devices 10a and 10b, a layout which causes the airflow generation devices 10a and 10b to generate exciting flows 25 in ascending and descending directions.

The term of “tilted in a substantial inverted V-shape” is intended to mean, in the example of airflow generation devices 10a and 10b, a layout in which these devices are arranged tilted in opposite directions to each other with a predetermined angle maintained to the ascending and descending directions. In this case, exciting flows 25 are generated from the airflow generation devices 10a and 10b, at a predetermined angle to the ascending and descending directions. At this time, the predetermined angle may be experimentally determined so that airflows from a top end part of the car 31 into the front side of the car 31 can be effectively rectified.

According to the layouts as described above, flows around the rectification covers can be more effectively rectified, and more reduction of aerodynamic noise can be expected accordingly.

Still alternatively, a greater number of airflow generation devices than described above may be used and arranged so as to rectify flows around the rectification covers, and may be driven at predetermined timings, respectively.

### Third Embodiment

Next, the third embodiment of the present invention will be described.

FIGS. 12A and 12B are views illustrating a configuration of an elevator according to the third embodiment of the invention. FIG. 12A is a side view of a car running in an elevation path. FIG. 12B is a front view of the car observed in a direction A. Components in FIGS. 12A and 12B which are common to the configuration in FIGS. 6A and 6B according to the first embodiment will be denoted at common reference symbols, and descriptions thereof will be omitted herefrom.

A rectification cover 32a is attached to an upper end part of a car 31, and a rectification cover 32b is attached to a lower end part of the car 31. Further, rectification spoilers 39a and 39b each having a steep shape are provided on the rectification covers 32a and 32b, protruded in ascending and descending directions. The rectification spoilers 39a and 39b are members for reducing aerodynamic noise during high speed running, and are fixed onto the rectification covers 32a and 32b by, for example, screwing so as to protrude in ascending and descending directions.

In the third embodiment, two airflow generation devices 10a and 10b are provided on a surface of a top end part of the rectification spoiler 39a, which faces a side of an elevation path 35 facing platforms. Similarly, two airflow generation devices 10c and 10d are provided on a surface of a top end part of the rectification spoiler 39b, which faces the side of the elevation path 35 facing the platforms.

The airflow generation devices 10a, 10b, 10c, and 10d each have a configuration as illustrated in FIG. 1 or 3, and are driven at predetermined timings by a drive device 11 during running of the car 31.

The predetermined timings are, specifically, when a top end part of the rectification spoiler 39a passes each hall sill 36 during an ascent of the car 31 and when a top end part of the rectification spoiler 39b passes each hall sill 36 during a descent of the car 31.

The drive device 11 is set on the car 31. A control device 12 illustrated in FIG. 9 detects a position of the car 31, based on a position signal output from a car position detection device 13. When the car 31 passes a predetermined position, the control device 12 controls driving of the airflow generation devices 10a, 10b, 10c, and 10d by the drive device 11.

In the example of FIGS. 12A and 12B, the airflow generation devices 10a and 10b are simultaneously driven to generate exciting flows 25 in a descending direction of the car 31 when the top end part of the rectification spoiler 39a passes each hall sill 36 during an ascent of the car 31. On the other side, the airflow generation devices 10c and 10d are simultaneously driven to generate exciting flows 25 in an ascending direction of the car 31 when the top end part of the rectification spoiler 39b passes each hall sill 36 during a descent of the car 31.

Thus, in the car 31 with rectification spoilers, the airflow generation devices 10a and 10b are provided on the top end part of the rectification spoiler 39a, and the airflow generation devices 10c and 10d are provided on the top end part of the rectification spoiler 39b. In this manner, when the top end parts of the rectification spoilers 39a and 39b are about to pass narrow parts 37 such as hall sills 36, airflows flowing into the front side of the car 31 can be rectified. As a result, pressure fluctuation caused by the narrow parts 37 during high speed running can be suppressed, and generation of aerodynamic noise can accordingly be suppressed.

As in the example of FIGS. 12A and 12B, the airflow generation devices 10a and 10b and the airflow generation devices 10c and 10d are arranged tandem in the ascending and descending directions respectively at the top end parts of the rectification spoilers 39a and 39b. In this manner, flows around the rectification spoilers can be more effectively rectified, and more reduction of aerodynamic noise can accordingly be expected.

### Fourth Embodiment

Next, the fourth embodiment of the present invention will be described.

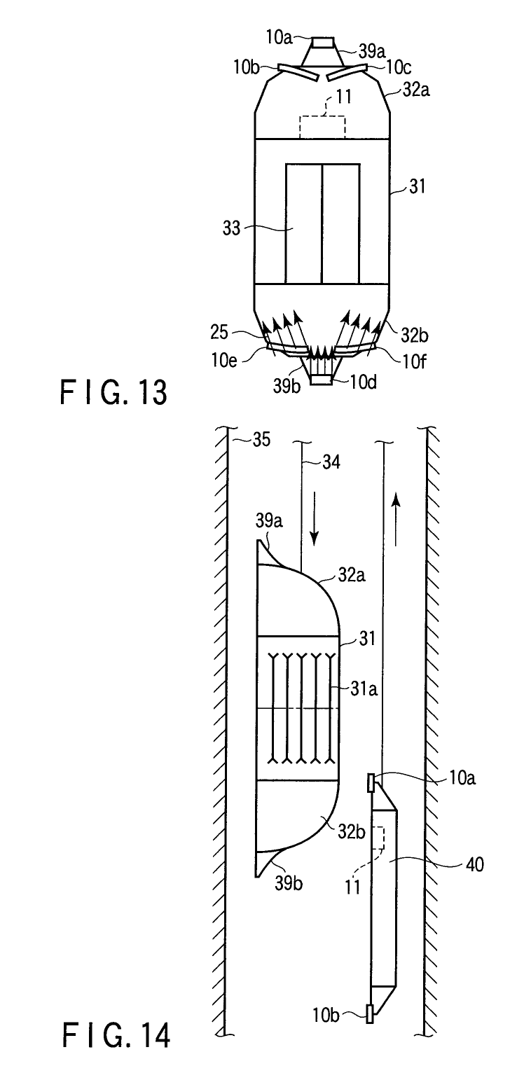

FIG. 13 is a diagram illustrating a configuration of a car of an elevator according to the fourth embodiment of the invention. As in the third embodiment, a rectification cover 32a and a rectification spoiler 39a are attached to an upper end part of a car 31, and a rectification cover 32b and a rectification spoiler 39b are attached to a lower end part of the car 31.

In the fourth embodiment, airflow generation devices are provided at a top end part of the rectification cover 32a, in addition to airflow generation devices attached to top end parts of the rectification spoilers 39a and 39b. That is, in the example of FIG. 13, one airflow generation device 10a is provided at the top end part of the rectification spoiler 39a, and two airflow generation devices 10b and 10c are provided tilted in a substantial inverted V-shape, at the top end part of the rectification cover 32a. Similarly, one airflow generation device 10d is provided at the top end part of the rectification spoiler 39b, and two airflow generation devices 10e and 10f are provided tilted in a substantial inverted V-shape, at the top end part of the rectification cover 32b.

The airflow generation devices 10a to 10c and 10d to 10f each have a configuration as illustrated in FIG. 1 or 3, and are driven at predetermined timings by a drive device 11 during running of the car 31.

The predetermined timings are, specifically, when a top end part of the rectification spoiler 39a passes each hall sill 36 during an ascent of the car 31 and when a top end part of the rectification spoiler 39b passes each hall sill 36 during a descent of the car 31.

The drive device 11 is set on the car 31. A control device 12 illustrated in FIG. 9 detects a position of the car 31, based on a position signal output from a car position detection device 13. When the car 31 passes a predetermined position, the control device 12 controls driving of the airflow generation devices 10a to 10f by the drive device 11.

In the example of FIG. 13, the airflow generation devices 10a, 10b, and 10c are simultaneously driven to generate exciting flows 25 in a descending direction of the car 31 when the top end part of the rectification spoiler 39a passes each hall sill 36 during an ascent of the car 31. On the other side, the airflow generation devices 10d, 10e, and 10f are simultaneously driven to generate exciting flows 25 in an ascending direction of the car 31 when the top end part of the rectification spoiler 39b passes each hall sill 36 during a descent of the car 31.

Thus, in the car 31 with rectification covers and rectification spoilers, the airflow generation devices 10a to 10c and the airflow generation devices 10d to 10f are provided respectively on the top end parts of the rectification covers 32a and 32b and the rectification spoilers 39a and 39b. In this manner, when the top end parts of the rectification spoilers 39a and 39b are about to pass narrow parts 37 such as hall sills 36, airflows flowing into the front side of the car 31 can be rectified. As a result, pressure fluctuation caused by the narrow parts 37 during high speed running can be suppressed, and generation of aerodynamic noise can accordingly be suppressed.

Although the airflow generation devices 10a and 10b as well as the airflow generation devices 10c and 10d are arranged tilted in a substantial inverted V-shape in the example of FIG. 13, the airflow generation devices 10a and 10b as well as the airflow generation devices 10c and 10d may be arranged tandem in ascending and descending directions.

Alternatively, a greater number of airflow generation devices than described above may be used and arranged so as to rectify flows around the rectification covers, and may be driven at predetermined timings, respectively.

### Fifth Embodiment

Next, the fifth embodiment of the present invention will be described.

In the fifth embodiment, aerodynamic noise and vibration which are generated when a counter weight and a car pass each other are reduced by providing airflow generation devices on a top end of a counter weight.

FIG. 14 is a side view illustrating configurations of a car and a counter weight in an elevator according to the fifth embodiment of the invention. Components in FIG. 14 which are common to configurations in FIGS. 6A and 6B according to the foregoing first embodiment will be denoted at common reference symbols, and descriptions thereof will be omitted herefrom.

FIG. 14 illustrates a state where a car 31 and a counter weight 40 pass each other during a descent of the car 31. The counter weight 40 is attached to another end of a rope 34, and is moved in an elevation path 35 along with the car 31 in accordance with driving of a winder not illustrated.

When a top end part of the counter weight 40 is about to pass the car 31 in an intermediate floor along the elevation path 35, there is a problem that local separated flows are generated at the top end part of the counter weight 40, thereby generating large pressure fluctuation, which generates aerodynamic noise and causes the car 31 to vibrate.

In this case, as illustrated in FIG. 14, aerodynamic noise and vibration generated when the counter weight 40 and the car 31 pass each other can be reduced to some extent by wedge-shaping a top end of the counter weight 40 so that a side of the wedge-shape close to the back of the car 31 is parallel. However, as the moving speed of the elevator increases, such a structural modification is not enough to satisfactorily reduce aerodynamic noise and vibration.

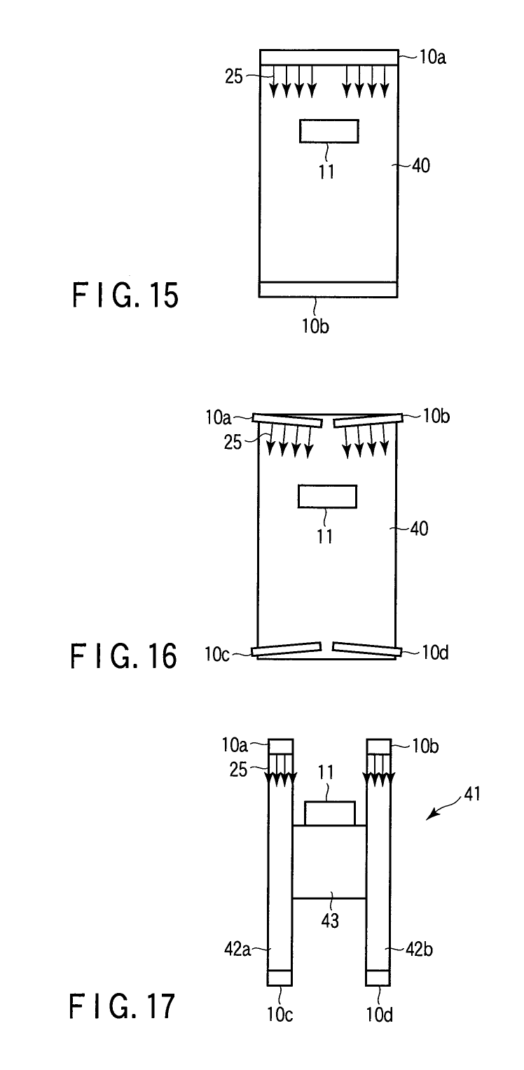

Hence, as illustrated in FIG. 15, airflow generation devices 10c and 10d are provided respectively on surfaces of upper and lower end parts of the counter weight 40 facing the car 31. As described previously, the airflow generation devices 10c and 10d each can be constructed as a module based on insulative material such as ceramics. Therefore, parts of such modules can be easily fixed to the counter weight 40 by screwing or an adhesive.

The airflow generation devices 10a and 10b each have a configuration as illustrated in FIG. 1 or 3, and are driven at predetermined timings by a drive device 11 during running of the car 31.

The predetermined timings are, specifically, when a lower end part of the counter weight 40 passes the car 31 during an ascent of the car 31 and when a top end part of the counter weight 40 passes the car 31 during a descent of the car 31.

The drive device 11 is set on the counter weight 40. A control device 12 illustrated in FIG. 9 detects a position of the car 31, based on a position signal output from a car position detection device 13. At the timing when the car 31 and the counter weight 40 pass each other, the control device 12 controls driving of the airflow generation devices 10a and 10b by the drive device 11. The control device 12 and the drive device 11 on the counter weight 40 are electrically connected by a cable not illustrated or wirelessly.

In the example of FIG. 14, the airflow generation device 10b is driven to generate exciting flows 25 in a direction (ascending direction) opposite to the moving direction of the counter weight 40 when the lower end part of the counter weight 40 passes the car 31 during an ascent of the car 31. On the other side, the airflow generation device 10a is driven to generate exciting flows 25 in a direction (descending direction) opposite to the moving direction of the counter weight 40 when the upper end part of the counter weight 40 passes the car 31 during a descent of the car 31.

Thus, the airflow generation devices 10a and 10b provided on the upper and lower end parts of the counter weight 40 are caused to generate exciting flows 25 in a direction opposite to the moving direction of the counter weight 40. Then, from the same logic as in the case of the car 31 described referring to FIGS. 7A and 7B, airflows flowing from the top end part of the counter weight 40 toward a surface of the counter weight 40 facing the car 31 can be smoothly rectified. In this manner, pressure fluctuation caused when the car 31 and the counter weight 40 pass each other can be suppressed, and aerodynamic noise and vibration can accordingly be suppressed.

### Sixth Embodiment

Next, the sixth embodiment of the present invention will be described.

FIG. 16 illustrates a configuration of a counter weight according to the sixth embodiment of the invention. A car has the same configuration as that in FIG. 14 according to the above fifth embodiment.

In the sixth embodiment, two airflow generation devices 10a and 10b are provided on a surface of an upper end part of the counter weight 40, which faces the car 31. Similarly, two airflow generation devices 10c and 10d are provided on the surface of a lower end part of the counter weight 40, which faces the car 31.

The airflow generation devices 10a, 10b, 10c, and 10d each have a configuration as illustrated in FIG. 1 or 3, and are driven at predetermined timings by a drive device 11 during running of the car 31.

The predetermined timings are when a lower end part of the counter weight 40 passes the car 31 during an ascent of the car 31 and when a top end part of the counter weight 40 passes the car 31 during a descent of the car 31.

The drive device 11 is set on the counter weight 40. A control device 12 illustrated in FIG. 9 detects a position of the car 31, based on a position signal output from a car position detection device 13. At the timing when the car 31 and the counter weight 40 pass each other, the control device 12 controls driving of the airflow generation devices 10a, 10b, 10c, and 10d by the drive device 11. The control device 12 and the drive device 11 on the counter weight 40 are electrically connected by a cable not illustrated or wirelessly.

In the example of FIG. 16, the airflow generation devices 10c and 10d are simultaneously driven to generate exciting flows 25 in a direction (ascending direction) opposite to the moving direction of the counter weight 40 when the lower end part of the counter weight 40 passes the car 31 during an ascent of the car 31. On the other side, the airflow generation devices 10a and 10b are driven to generate exciting flows 25 in a direction (descending direction) opposite to the moving direction of the counter weight 40 when the upper end part of the counter weight 40 passes the car 31 during a descent of the car 31.

Thus, the airflow generation devices 10a and 10b and the airflow generation devices 10c and 10d are provided respectively on the upper and lower end parts of the counter weight 40. Then, airflows flowing from top end parts of the counter weight 40 toward a surface of the counter weight facing the car 31 can be effectively rectified. As a result, pressure fluctuation caused when the car 31 and the counter weight 40 pass each other can be suppressed, and aerodynamic noise and vibration can accordingly be suppressed.

The airflow generation devices 10a and 10b as well as the airflow generation devices 10c and 10d may be arranged tandem in ascending and descending directions. Alternatively, as in the example of FIG. 16, the airflow generation devices 10a and 10b as well as the airflow generation devices 10c and 10d may be tilted in a substantial inverted V-shape so that air around a top end part of the counter weight 40 smoothly flows toward sides. According to such layouts, flows around top end parts of the counter weight 40 can be more effectively rectified, and more reduction of aerodynamic noise can accordingly be expected.

Still alternatively, a greater number of airflow generation devices than described above may be used and arranged so as to rectify flows around the rectification covers, and may be driven at predetermined timings, respectively.

### Seventh Embodiment

Next, the Seventh embodiment of the present invention will be described.

FIG. 17 illustrates a configuration of a counter weight in an elevator according to the seventh embodiment of the invention. A car has the same configuration as that in FIG. 14 according to the above fifth embodiment.

The seventh embodiment uses a counter weight 41 having a shape divided into two of left and right pieces to reduce aerodynamic noise generated when passing a car 31. The counter weight 41 is constituted by two columnar weight members 42a and 42b extended in ascending and descending directions, and a link part 43 which links the weight members 42a and 42b.

Airflow generation devices 10c and 10d are respectively provided on upper end parts of the counter weight 41, as well as airflow generation devices 10c and 10d are respectively provided on lower end parts of counter weight 41.

The airflow generation devices 10a, 10b, 10c, and 10d each have a configuration as illustrated in FIG. 1 or 3, and are driven at predetermined timings by a drive device 11 during running of the car 31.

The predetermined timings are when a lower end part of the counter weight 41 passes the car 31 during an ascent of the car 31 and when a top end part of the counter weight 41 passes the car 31 during a descent of the car 31.

The drive device 11 is set between the weight members 42a and 42b of the counter weight 41. A control device 12 illustrated in FIG. 9 detects a position of the car 31, based on a position signal output from a car position detection device 13. At the timing when the car 31 and the counter weight 41 pass each other, the control device 12 controls driving of the airflow generation devices 10a, 10b, 10c, and 10d by the drive device 11. The control device 12 and the drive device 11 on the counter weight 41 are electrically connected by a cable not illustrated or wirelessly.

In the example of FIG. 17, the airflow generation devices 10c and 10d are simultaneously driven to generate exciting flows 25 in a direction (ascending direction) opposite to the moving direction of the counter weight 41 when the lower end part of the counter weight 41 passes the car 31 during an ascent of the car 31. On the other side, the airflow generation devices 10a and 10b are driven to generate exciting flows 25 in a direction (descending direction) opposite to the moving direction of the counter weight 41 when the upper end part of the counter weight 41 passes the car 31 during a descent of the car 31.

Thus, in the counter weight 41 of a two-piece type, the airflow generation devices 10a and 10b and the airflow generation devices 10c and 10d are provided on upper end parts of the weight members 42a and 42b and on the lower end parts thereof, respectively. In this manner, airflows flowing from top end parts of the counter weight 41 toward a surface of the counter weight 41 facing the car 31 can be rectified. As a result, pressure fluctuation caused when the car 31 and the counter weight 41 pass each other can be suppressed, and aerodynamic noise and vibration can accordingly be suppressed.

### Eighth Embodiment

Next, the eighth embodiment of the present invention will be described.

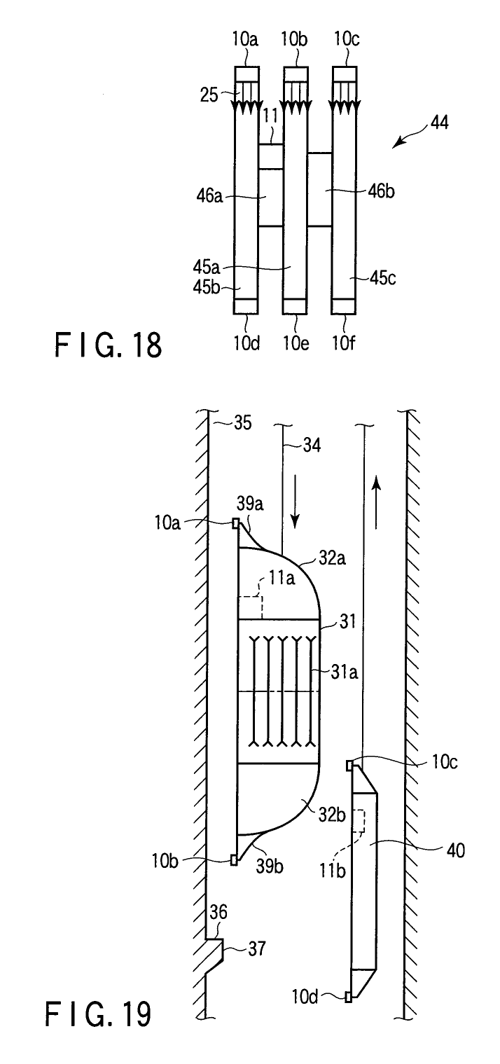

FIG. 18 illustrates a configuration of a counter weight of an elevator according to the eighth embodiment of the invention. A car has the same configuration as that in FIG. 14 according to the above fifth embodiment.

The eighth embodiment uses a counter weight 44 of a three-piece type to reduce aerodynamic noise generated when passing a car 31. The counter weight 44 is constituted by three columnar weight members 45a, 45b, and 45c extended in elevation directions, and link parts 46a and 46b which link the weight members 45a, 45b, and 45c.

Airflow generation devices 10a, 10b, and 10c are provided respectively on upper end parts of weight members 45a, 45b, and 45c of the counter weight 44, and airflow generation devices 10d, 10e, and 10f are provided respectively on lower end parts of the weight members 45a, 45b, and 45c of the counter weight 44.

A method for driving the airflow generation devices 10a to 10f is the same as that in the above seventh embodiment. That is, the airflow generation devices 10d to 10f are simultaneously driven to generate exciting flows 25 in a direction (ascending direction) opposite to the moving direction of the counter weight 44 when the lower end parts of the counter weight 44 pass the car 31 during an ascent of the car 31.

On the other side, the airflow generation devices 10a to 10c are simultaneously driven to generate exciting flows 25 in a direction (descending direction) opposite to the moving direction of the counter weight 44 when the upper end parts of the counter weight 44 pass the car 31 during a descent of the car 31.

Thus, in the counter weight 44 of a three-piece type, the airflow generation devices 10a, 10b, and 10c and the airflow generation devices 10d, 10e, and 10d are provided respectively on the upper and lower end parts of the weight members 45a, 45b, and 45c. In this manner, airflows flowing from the top end parts of the counter weight 44 toward surfaces of the top end parts facing the car 31 can be rectified. As a result, pressure fluctuation caused when the car 31 and the counter weight 44 pass each other can be suppressed, and aerodynamic noise and vibration can accordingly be suppressed.

Furthermore, the same description as made above also applies to a counter weight divided into a greater number of pieces than described above. The same effects as described above can be obtained by simply providing airflow generation devices respectively at upper and lower end parts of weight members extended in ascending and descending directions.

### Ninth Embodiment

Next, the ninth embodiment of the present invention will be described.

FIG. 19 is a side view illustrating configurations of a car and a counter weight of an elevator according to the ninth embodiment of the invention. Components in FIG. 19 which are common to configurations in FIG. 14 according to the fifth embodiment will be denoted at common reference symbols, and descriptions thereof will be omitted herefrom.

In the ninth embodiment, both of a car 31 and a counter weight 40 are provided with airflow generation devices. That is, for the car 31, airflow generation devices 10a and 10b are provided on surfaces of top end parts of rectification spoilers 39a and 39b, which face a side of an elevation path 35 facing platforms. For the counter weight 40, airflow generation devices 10c and 10d are provided on surfaces of upper and lower end parts of the counter weight 40, which face the car 31.

The airflow generation devices 10a and 10b provided on the car 31 each have a configuration as illustrated in FIG. 1 or 3, and are driven at predetermined timings by a first drive device 11a during running of the car 31.

The predetermined timings are, specifically, when a top end part of the rectification spoiler 39a passes each hall sill 36 during an ascent of the car 31 and when a top end part of the rectification spoiler 39b passes each hall sill 36 during a descent of the car 31.

The first drive device 11a is set on the car 31. A control device 12 illustrated in FIG. 9, as a first control unit, detects a position of the car 31, based on a position signal output from a car position detection device 13. When the car 31 passes a predetermined position, the control device 12 controls driving of the airflow generation devices 10a and 10b by the first drive device 11a.

In the example of FIG. 19, the airflow generation device 10a is driven to generate exciting flows 25 in a descending direction of the car 31 when the top end part of the rectification spoiler 39a passes each hall sill 36 during an ascent of the car 31. On the other side, the airflow generation device 10b is driven to generate exciting flows 25 in an ascending direction of the car 31 when the top end part of the rectification spoiler 39b passes each hall sill 36 during a descent of the car 31.

The airflow generation devices 10c and 10d provided on the counter weight 40 each have a configuration as illustrated in FIG. 1 or 3, and are driven at predetermined timings by a second drive device 11b during running of the car 31.

The predetermined timings are, specifically, when a lower end part of the counter weight 40 passes the car 31 during an ascent of the car 31 and when a top end part of the counter weight 40 passes the car 31 during a descent of the car 31.

The second drive device 11b is set on the counter weight 40. A control device 12 illustrated in FIG. 9, as a second control unit, detects a position of the car 31, based on a position signal output from a car position detection device 13. At the timing when the car 31 and the counter weight 40 pass each other, the control device 12 controls driving of the airflow generation devices 10c and 10d by the drive device 11. The control device 12 and the drive device 11b on the counter weight 40 are electrically connected by a cable not illustrated or wirelessly.

In the example of FIG. 19, the airflow generation device 10c is driven to generate exciting flows 25 in a direction (ascending direction) opposite to the moving direction of the counter weight 40 when the lower end part of the counter weight 40 passes the car 31 during an ascent of the car 31.

On the other side, the airflow generation device 10d is driven to generate exciting flows 25 in a direction (descending direction) opposite to the moving direction of the counter weight 40 when the upper end part of the counter weight 40 passes the car 31 during a descent of the car 31.

Thus, the airflow generation devices 10a and 10b and the airflow generation devices 10c and 10d are provided on both of the car 31 and the counter weight 40, and are driven to generate exciting flows 25 at respectively proper timings. In this manner, pressure fluctuation caused when the car 31 passes narrow parts 37 such as hall sills 36 can be suppressed, and aerodynamic noise caused when the car 31 and the counter weight 40 pass each other can be suppressed as well. As a result, an elevator which is felt always comfortable even during high speed running can be provided.

The configuration of the car 31 is not limited to the example of FIG. 19 but may alternatively be arranged such that only rectification covers 32a and 32b are attached to the upper and lower end parts of the car 31. Also, the configuration of the counter weight 40 may be of a divided type as illustrated in FIG. 17 or 18.

### Tenth Embodiment

Next, the tenth embodiment of the invention will be described.

Above descriptions have been made assuming a high speed elevator including a car with rectification covers. However, the invention is not limited to such a high speed elevator but is also effective for an ordinary low speed elevator including a box-shaped car. The term “low speed elevator” herein refers to elevators which run at a “low speed” or “middle speed” according to speed classification under the Building Standards Law described previously.

Recently, in order to reduce as much as possible a gap between a platform and a car from a viewpoint of barrier-free, a great number of low speed elevators are designed so that narrow parts of an elevation path are 30 mm or less. In such low speed elevators, loud aerodynamic noise is sometimes generated when a car passes narrow parts of an elevation path even if the car moves at a low speed.

A configuration for reducing aerodynamic noise will now be described below assuming such a low speed elevator.

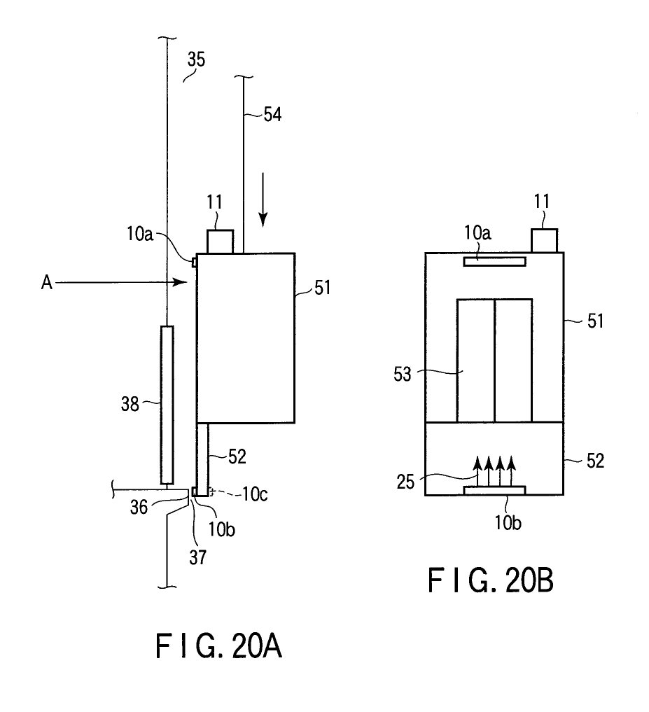

FIGS. 20A and 20B are views illustrating a configuration of an elevator according to the tenth embodiment of the invention. FIG. 20A is a side view of a car running in an elevation path. FIG. 20B is a front view of the car observed in a direction A.

The elevator according to the present embodiment includes a box-shaped car 51 which is mainly used in low speed elevators. The car 51 ascends and descends in an elevation path 35, by a rope 54 which is driven by a winder not illustrated.

A fall guard plate 52 which is commonly known as an “apron” is attached to a lower end part of the car 51 on a side thereof facing platforms. The fall guard plate 52 is a plate member which prevents things from falling through a gap between hall sills 36 of platforms and a car door 53. The fall guard plate 52 is extended by a predetermined length from an edge of the car door 53 in a descending direction.

The elevation path 35 has the same configuration as that illustrated in FIGS. 6A and 6B.

That is, the elevation path 35 is provided with hall sills 36 at platforms on respective floors. A hall door 38 is provided to be openable/closable on each hall sill 36. In front of the car 51, the car door 53 is provided to be openable/closable. When the car 51 stops at the platform on each floor, the car door 53 opens/closes in engagement with the hall door 38. Reference symbol 37 in the figures denotes a narrow part formed by a hall sill 36 in the elevation path 35.

An airflow generation device 10a is provided on a surface of a top end part of the car 51, which faces a side of the elevation path 35 facing platforms. An airflow generation device 10b is provided on a surface of a top end part of the fall guard plate 52 attached to a lower end of the car 51, the surface facing the side of the elevation path 35 facing the platforms. As has been described above, the airflow generation devices 10a and 10b each can be constructed as a module based on insulative material such as ceramics. Therefore, parts of such modules can be easily fixed to the car 51 and the fall guard plate 52 by screwing or an adhesive.

The airflow generation devices 10a and 10b each have a configuration as illustrated in FIG. 1 or 3, and are driven at predetermined timings by a drive device 11 during running of the car 51.

The predetermined timings are, specifically, when the upper end part of the car 51 passes each hall sill 36 during an ascent of the car 51 and when the lower end part of the car 51 passes each hall sill 36 during a descent of the car 31.

The drive device 11 is set on the car 51. A control device 12 illustrated in FIG. 9 detects a position of the car 51, based on a position signal output from a car position detection device 13. When the car 51 passes a predetermined position, the control device 12 controls driving of the airflow generation devices 10a and 10b by the drive device 11.

In the example of FIGS. 20A and 20B, the airflow generation device 10a is driven to generate exciting flows 25 in a descending direction of the car 51 when the top end part of the car 51 passes each hall sill 36 during an ascent of the car 31. On the other side, the airflow generation device 10b is driven to generate exciting flows 25 in an ascending direction of the car 51 when the top end part of the fall guard plate 52 passes each hall sill 36 during a descent of the car 51.

Assuming that the car 51 is now descending, operation and effects of the airflow generation device 10b will be described below.

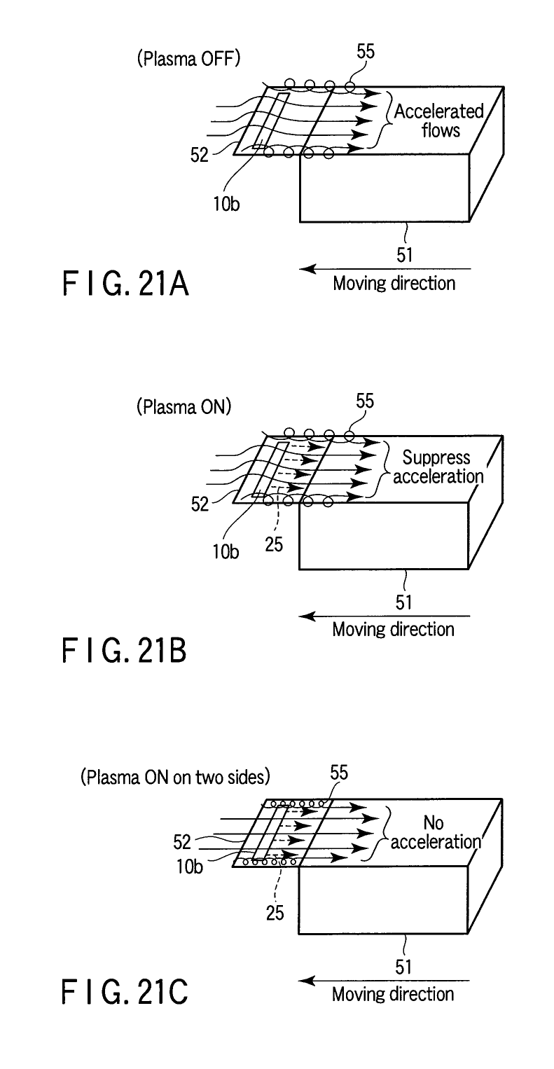

FIGS. 21A, 21B, and 21C are views illustrating states of airflows occurring at a top end part of a fall guard plate of a car. FIG. 21A illustrates a state of plasma OFF. FIG. 21B illustrates a state of plasma ON. FIG. 21C illustrates a state of plasma ON on two sides.

As illustrated in FIG. 21A, when the top end part of the fall guard plate 52 of the car 51 is about to pass narrow parts 37 such as hall sills 36 on the elevation path 35 during a descent of the car 51, air dammed by the top end part of the fall guard plate 52 abruptly flows into the front side of the car 51, and local accelerated flows occur in front of the car door 53. Further, longitudinal vortices 55 are generated at an end part of the fall guard plate 52. The longitudinal vortices 55 further accelerate the accelerated flows in front of the car door 53. Such accelerated flows cause large pressure fluctuation, which results in generation of aerodynamic noise.

As illustrated in FIG. 21B, if exciting flows 25 are generated in a direction (i.e., ascending direction) opposite to the moving direction of the car 51 from the airflow generation device 10b during a descent of the car 51, a phenomenon of damming at the top end part of the fall guard plate 52 is eliminated. Airflows flowing into the front side of the car 51 from the top end part can be thereby smoothly rectified around the car. Accordingly, pressure fluctuation is suppressed, and aerodynamic noise can be suppressed as a result.

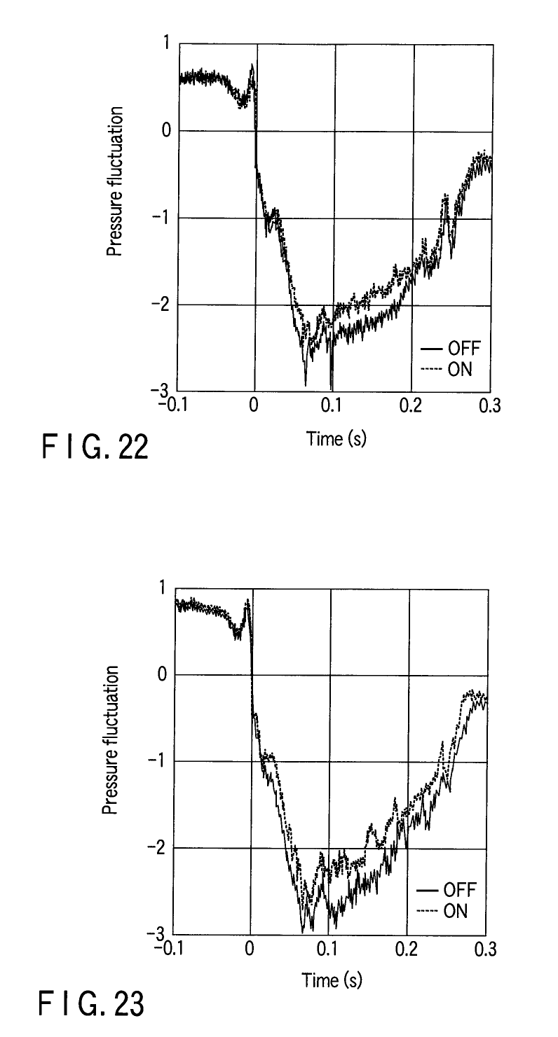

FIG. 22 represents a result of measuring pressure fluctuation in case where a car is made run at a predetermined speed in an elevation path in a scale model experiment. The horizontal axis represents time and the vertical axis represents a fluctuation value relative to a pressure before the car passes. In the figure, a continuous line represents a characteristic of plasma OFF, and a broken line represents a characteristic of plasma ON.

Abrupt pressure fluctuation occurs when the top end part of the car 51 passes a narrow part 37 on the elevation path 35. However, if exciting flows 25 are generated in advance in a direction opposite to the moving direction of the car 51 by setting plasma ON, pressure fluctuation thereof is obviously suppressed and aerodynamic noise is accordingly reduced.

The same result as described above also applies to when the car 31 ascends.

That is, airflows flowing from the top end part of the car 51 into the front side thereof can be rectified by generating exciting flows 25 in a direction (i.e., descending direction) opposite to the moving direction of the car 51 from the airflow generation device 10a attached to the top end part of the car 51 when the top end part of the car 51 is about to pass the narrow part 37 such as a hall sill 37 on the elevation path 35. In this manner, pressure fluctuation can be suppressed, and aerodynamic noise can be suppressed as a result.

In general, pressure fluctuation during a descent is larger than that during an ascent. This is because, usually, air blows up from downside in the elevation path 35, although depending on structures of buildings. If the car 51 descends in such an elevation path 35, longitudinal vortices 55 rapidly grow up and come round into side end parts of the fall guard plate 52 at the narrow parts 37 such as hall sills 36.

Hence, as indicated by broken lines in FIGS. 20A and 20B, an airflow generation device 10c may be added to a back surface (which is opposite to platforms) of the fall guard plate 52, and the airflow generation devices 10b and 10c may be simultaneously driven during a descent of the car 51. In this configuration, action of the longitudinal vortices 55 generated at side end pars of the fall guard plate 52 can be weakened. Accordingly, as illustrated in FIG. 21C, airflows flowing from the top end part into the front side of the car 51 can be more smoothly rectified, thereby suppressing pressure fluctuation, and generation of aerodynamic noise can accordingly be suppressed.

FIG. 23 represents a result of measuring pressure fluctuation in case where the airflow generation devices 10b and 10c are provided on both surfaces of the fall guard plate 52. Obviously, pressure fluctuation is suppressed compared with a configuration of providing the airflow generation device 10b only on one surface of the fall guard plate 52. This is because, in the configuration of providing the airflow generation device 10b only on one surface of the fall guard plate 52, the longitudinal vortices 55 cannot be effectively suppressed although accelerated flows are suppressed.

### Eleventh Embodiment

Next, the eleventh embodiment of the present invention will be described.

The above first to tenth embodiments have been described assuming that airflow generation devices using discharge plasma are applied to an elevator. Alternatively, however, a synthetic jet device using a small-size vibration film can be used in place of an airflow generation device.

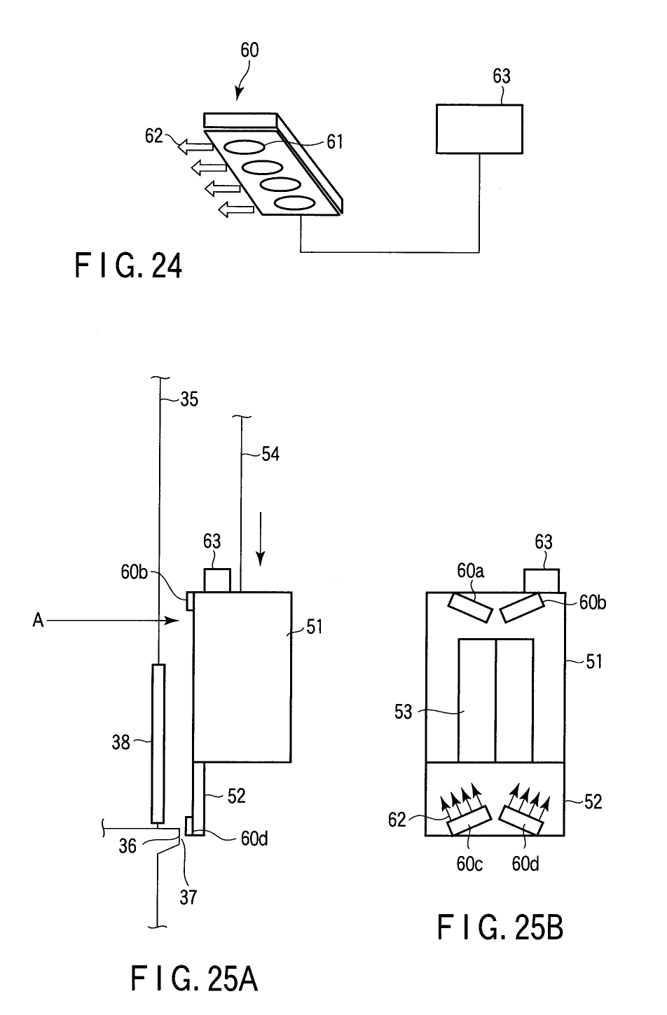

FIG. 24 is a diagram illustrating a configuration of a synthetic jet device according to the eleventh embodiment of the invention.

The synthetic jet device 60 includes a vibration film 61. A blow jet flow 62 is generated by vibrating the vibration film 61 by a drive device 63. Since the synthetic jet device is well known to public, a specific description of a configuration thereof will be omitted herefrom.

FIGS. 25A and 25B are views illustrating a configuration of an elevator in case where synthetic jet devices are used as airflow generation devices. FIG. 25A is a side view of a car running in an elevation path. FIG. 25B is a front view of the car from a direction A. Components in FIGS. 25A and 25B which are common to FIGS. 20A and 20B in the above tenth embodiment will be denoted at common reference symbols, and descriptions thereof will be omitted herefrom.

Two synthetic jet devices 60a and 60b are provided on a surface of a top end part of a box-shaped car 51, which faces a side of an elevation path 35 facing platforms. A fall guard plate 52 is attached to a lower end part of the car 51, and two synthetic jet devices 60c and 60d are provided on a surface of a top end part of the fall guard plate 52, which faces a side of the elevation path 35 facing platforms.

In a configuration as described above, jet flows 62 are generated in a direction (i.e., ascending direction) opposite to the moving direction of the car 51 by driving the synthetic jet devices 60c and 60d when the top end part of the fall guard plate 52 is about to pass narrow parts 37 such as hall sills 36 during a descent of the car 51. Then, influence of local accelerated flows around the car can be suppressed, and aerodynamic noise can be thereby suppressed.

On the other side, jet flows 62 are generated in a direction (i.e., descending direction) opposite to the moving direction of the car 51 by driving the synthetic jet devices 60a and 60b when the top end part of the car 51 is about to pass narrow parts 37 such as hall sills 36 during an ascent of the car 51. Then, influence of local accelerated flows around the car can be suppressed, and aerodynamic noise can be thereby suppressed.

The synthetic jet devices 60a and 60b as well as the synthetic jet devices 60c and 60d may be arranged tandem in ascending and descending directions. Alternatively, as illustrated in FIGS. 25A and 25B, the synthetic jet devices 60a and 60b as well as the synthetic jet devices 60c and 60d may be tilted in a substantial inverted V-shape.

### Twelfth Embodiment

Next, the twelfth embodiment of the present invention will be described.

In the twelfth embodiment, a small fan is used as an airflow generation device.

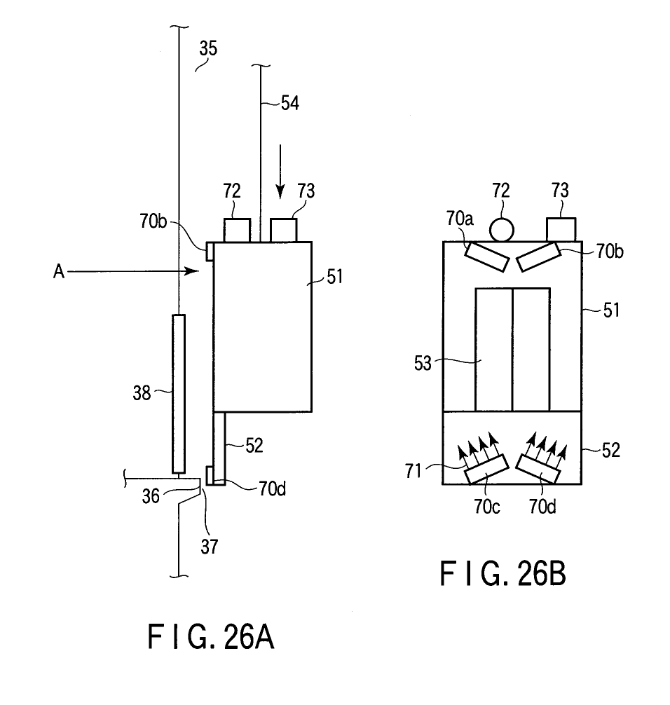

FIGS. 26A and 26B are views illustrating a configuration of an elevator in case where a small fan is used as an airflow generation device according to the twelfth embodiment of the invention. FIG. 26A is a side view of a car running in an elevation path. FIG. 26B is a front view of the car observed in a direction A. Components in FIGS. 26A and 26B which are common to FIGS. 20A and 20B in the above tenth embodiment will be denoted at common reference symbols, and descriptions thereof will be omitted herefrom.

Thin nozzles 70a and 70b including slit-type nozzle parts are provided on a surface of a top end part of a box-shaped car 51, which faces a side of an elevation path 35 facing platforms. A fall guard plate 52 is attached to a lower end part of the car 51. Thin nozzles 70c and 70d including slit-type nozzle parts are provided on a surface of a top end part of the fall guard plate 52, which faces a side of the elevation path 35 facing platforms. On the car 51, there are provided a small fan 72 for feeding winds to the nozzles 70a, 70b, 70c, and 70d, and a drive device 73 for driving the fan 72 to rotate.

In a configuration as described above, jet flows 71 are generated in a direction (i.e., ascending direction) opposite to the moving direction of the car 51 from the nozzles 70c and 70d by driving the fan 72 when the top end part of the fall guard plate 52 is about to pass narrow parts 37 such as hall sills 36 during a descent of the car 51. Then, influence of local accelerated flows around the car can be suppressed, and aerodynamic noise can be thereby suppressed.

On the other side, jet flows 72 are generated in a direction (i.e., descending direction) opposite to the moving direction of the car 51 from the nozzles 70a and 70b by driving the fan 72 when the top end part of the car 51 is about to pass narrow parts 37 such as hall sills 36 during an ascent of the car 51. Then, influence of local accelerated flows around the car can be suppressed, and aerodynamic noise can be thereby suppressed.

The nozzles 70a and 70b as well as the nozzles 70c and 70d may be arranged tandem in ascending and descending directions. Alternatively, as illustrated in FIGS. 26A and 26B, the nozzles 70a and 70b as well as the nozzles 70c and 70d may be tilted in a substantial inverted V-shape.

### Thirteenth Embodiment

Next, the thirteenth embodiment of the present invention will be described.

In case of a box-shaped car used in a low speed elevator as described in the foregoing tenth embodiment, noise reduction effect may sometimes be unsatisfactorily obtained due to a relationship with the shape of the car during an ascent even if an airflow generation device is provided on an upper end part of the car. The thirteenth embodiment is to eliminate such a problem.

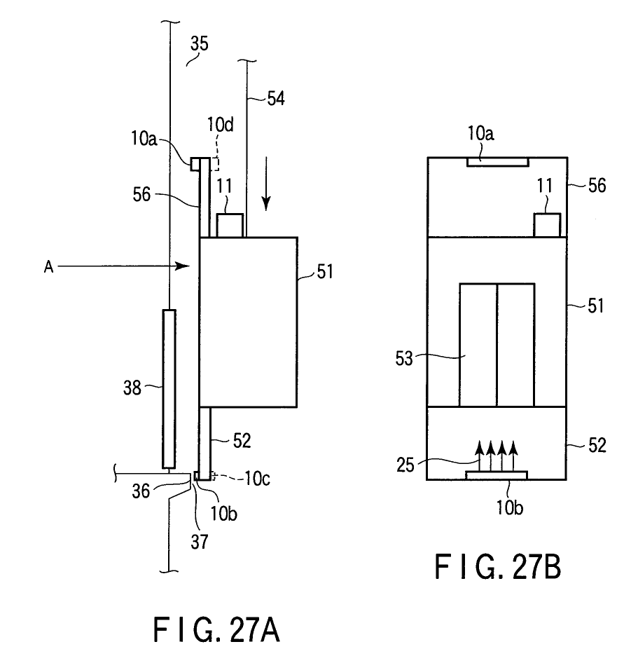

FIGS. 27A and 27B are views illustrating a configuration of an elevator according to the thirteenth embodiment of the invention. FIG. 27A is a side view of a car running in an elevation path.

FIG. 27B is a front view of the car observed in a direction A. Components which are common to FIGS. 20A and 20B in the foregoing tenth embodiment will be denoted at common reference symbols, and descriptions thereof will be omitted herefrom.

The present embodiment differs from the tenth embodiment in that a plate-type support member 56 is attached to an edge of an upper end part of the car 51 in a side facing platforms. The plate-type support member 56 is extended in an ascending direction by a predetermined length from the edge of the upper end part of the car 51 in the side facing platforms. An airflow generation device 10a is provided on a surface of a top end part of the support member 56, which faces a side of an elevation path 35 facing platforms.

Thus, the airflow generation device 10a is provided at an upper end part of the car 51 by the support member 56. Therefore, pressure fluctuation caused at narrow parts 37 such as hall sills 36 can be suppressed thereby effectively reducing aerodynamic noise, according to the same logics applied to the foregoing case of providing an airflow generation device 10a on a fall guard plate 52 as described with reference to FIGS. 21A, 21B, and 21C.

Further, if another airflow generation device 10d is set on a back surface of the support member 56 and is driven in the same manner as the airflow generation device 10a, noise reduction effect can be improved more.

A configuration as described above is applicable not only to airflow generation devices using plasma but also to synthetic jet devices (see FIG. 24) described in the foregoing eleventh embodiment and a fan (see FIGS. 26A and 26B) described in the foregoing twelfth embodiment. Noise reduction effect during an ascent can be attained by providing such a synthetic jet device or a fun on an upper end part of a box-shaped car for a low speed.

Further, in each of the above embodiments, airflows generated during running can be controlled by providing airflow generation devices on a car or counter weight. Positions and a method to attach airflow generation devices, and a method for generating airflows can be appropriately modified in practice.

The above embodiments have been described assuming that a control device of an elevator controls driving of airflow generation devices. However, a control device for controlling driving of airflow generation devices may be configured to be provided separately and set on a car or a counter weight, together with a drive device.

A method for detecting a position of a car is not limited to a method using a pulse encoder. For example, plural position sensors may be provided in an elevation path, and the position of a car may be detected based on signals output from the position sensors.

(Aerodynamic Noise Generation Mechanism)

As a supplementary description of airflow generation devices described above, a mechanism of generating aerodynamic noise (buff sound) during running of an elevator will be described in details below, referring to examples of low to high speed elevators.

In accordance with recent popularization of barrier-free, a gap between hall sills and a car is demanded to be narrower and narrower so that wheels of wheelchairs and baby buggies may not run off. Therefore, narrow parts in an elevation path are so narrowed that even low to high speed elevators which have not ever caused troubles come to cause local aerodynamic noise (buff sound) when cars pass such narrow parts.

In low to high speed elevators, a fall guard plate 52 which is commonly known as an “apron” is attached to a lower end part of a car 51 on a side facing platforms, as has been described referring to FIGS. 20A and 20B. The fall guard plate 52 is extended by a predetermined length from an edge of a car door 53 in a descending direction.

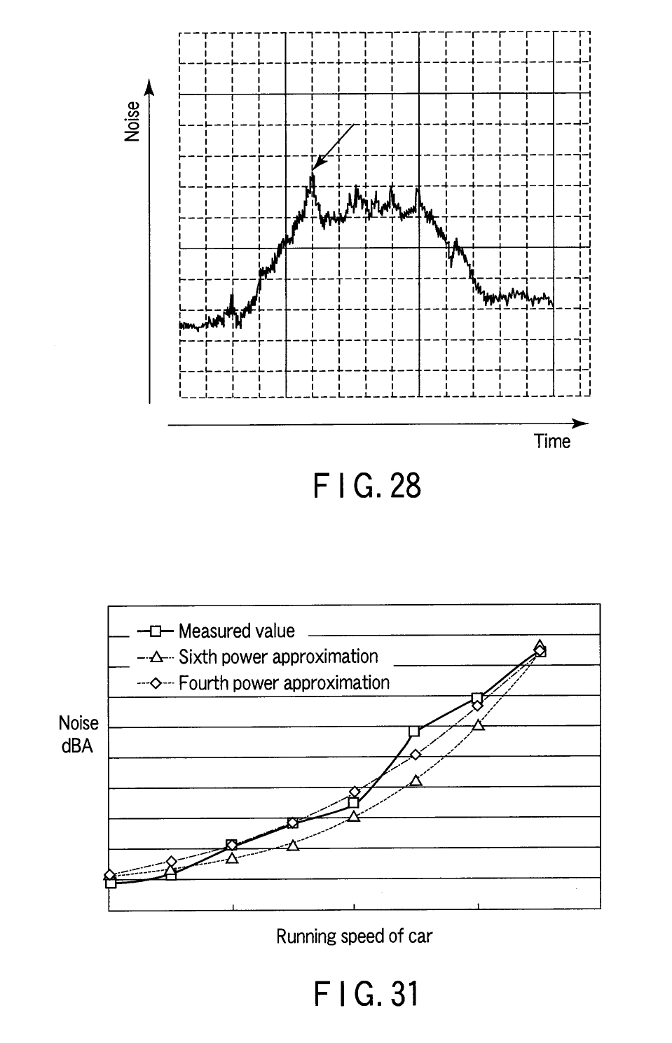

FIG. 28 represents a result of monitoring aerodynamic noise generated during running while measuring car positions, with respect to low to high speed elevators having a shape as described above.

In FIG. 28, the horizontal axis represents time, and the vertical axis represents noise loudness. When a car 51 is made descend at a predetermined speed, large pressure fluctuation is caused and aerodynamic noise is generated, at an instance when a top end part of a fall guard plate 52 is about to pass a narrow part 37 (see an arrow in the figure).

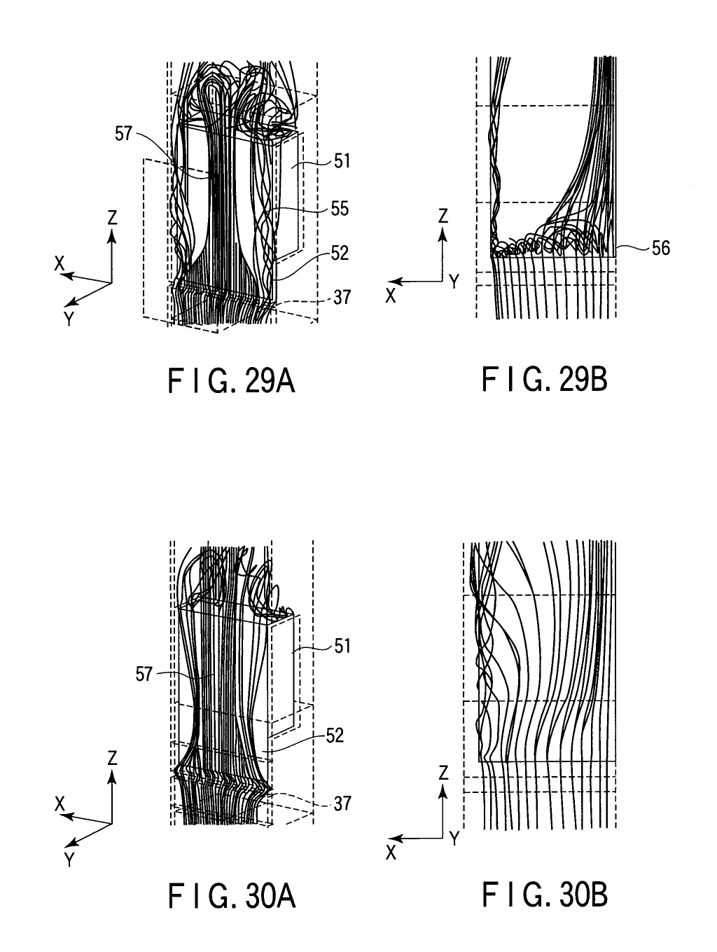

Hence, airflows around a car during running of an elevator were reproduced by Computational Fluid Dynamics (CFD), and causes of generating aerodynamic noise were specified and represented graphically in FIGS. 29A and 29B.

FIG. 29A represents airflows when a top end part of the fall guard plate 52 provided on a lower end part of the car 51 was about to pass a narrow part 37 in an elevation path. FIG. 29B is a front view of partially extracted airflows within a frame of a broken line in FIG. 29A.

When the top end part of the fall guard plate 52 is about to pass narrow parts 37, airflows are dammed by the top end part of the fall guard plate 52 and cause large pressure fluctuation, thereby generating aerodynamic noise.

Particularly, as represented in FIG. 29B, Computational Fluid Dynamics have revealed that separation bubbles 56 exist at the top end part of the fall guard plate 52 and promote pressure fluctuation.

That is, pressure loss at a gap between a car 51 and narrow parts 37 increases due to the separation bubbles 56 occurring at the top end part of the fall guard plate 52, and damming effect is promoted. As a result, longitudinal vortices 55 abruptly grow and enter from two sides of the fall guard plate 52. Airflows from the top end part of the longitudinal vortices 55 are converged at a center part in front of the car 51, and accelerate as contracted accelerating flows 57. The longitudinal vortices 55 and the contracted accelerating flows 57 abruptly reduce pressure in front of the car, according to Bernoulli's Theorem, and causes large pressure fluctuation.

As expressed in FIGS. 20A and 20B, if exciting flows 25 are now generated at the top end part of the fall guard plate 52 by the airflow generation device 10b, separation flows at the top end part of the fall guard plate 52 are suppressed by the exciting flows 25, and generation of the longitudinal vortices 55 are weakened. In this manner, convergence of streamlines of flows in front of the car 51 is suppressed.

FIGS. 30A and 30B express analysis results in case where suppressing separation flows by generating exciting flows 25 at the top end part of the fall guard plate 52. Obviously, the separation bubbles 56 at the top end part of the fall guard plate 52 are contracted by generation of the exciting flows 25, and the longitudinal vortices 55 and the contracted accelerating flows 57 are accordingly suppressed and rectified.

Thus, pressure fluctuation can be suppressed and aerodynamic noise can accordingly be reduced by rectifying disturbance of airflows which is caused when the top end part of the fall guard plate 52 is about to pass narrow parts 37.

Meanwhile, aerodynamic noise generated during running of an elevator or an automobile is caused by nonsteady motion of vortices existing in airflows disturbed by the running. Such aerodynamic noise can be calculated from a wave equation (Lighthill's equation) which is obtained by transforming Navier-Stokes equations as fundamental hydrodynamic equations. The wave equation is cited below as equation 1.

$$\begin{matrix}\frac{{\partial }^{2}}{\partial {t}^{2}} ρ - c {∇}^{2} ρ = \frac{\partial }{\partial {x}_{i }} \frac{\partial }{\partial {x}_{j}} [ \begin{matrix}ρ {v}_{i} {v}_{j} + ( p - {c}^{2} ρ ) {δ}_{ij} + \\ μ ( \frac{\partial {v}_{i}}{\partial {x}_{j}} + \frac{\partial {v}_{j}}{\partial {x}_{i }} ) - \frac{2}{3} {μδ}_{ij} \frac{\partial {v}_{k}}{\partial {x}_{k}}\end{matrix} ] - \\ \frac{\partial }{\partial {x}_{i}} {F}_{i} \\ = \frac{\partial }{\partial {x}_{i}} \frac{\partial }{\partial {x}_{j}} {T}_{ij} - \frac{\partial }{\partial {x}_{i}} {F}_{i}\end{matrix} \qquad ( 1 )$$

In the above equation 1, c denotes the sonic speed; p denotes pressure; ρ denotes concentration; x denotes coordinates; v denotes speed, μ denotes a viscosity coefficient; F denotes external force; δij denotes Kronecker delta; and Tij denotes Lighthill's tensor.

The above equation 1 is further transformed and subjected to dimensional analysis to evaluate orders of respective terms. Accordingly, sound radiation from an aerodynamic noise source can be expressed as follows.

$${p}^{2} = 4 π {r}^{2} {c}^{2} \frac{{ρ}^{2}}{{ρ}_{0}} \approx \frac{{ρ}_{0}}{c} {u}^{4} {l}^{2} + \frac{{ρ}_{0}}{{c}^{3}} {u}^{6} {l}^{2} + \frac{{ρ}_{0}}{{c}^{5}} {u}^{8} {l}^{2} \qquad ( 2 )$$

In the above equation 2, sound pressure p=c²ρ, ρ₀ is an average value of concentrations; r denotes a distance from a sound source; 1 denotes a scale of a vortex; and u is a speed.

The first term in the above equation 2 indicates that aerodynamic noise accompanied by volume change of airflows, such as upwelling and suctioning flows, is generated in proportion to the fourth power of a speed. The second term indicates that noise generated by change in quantity of motion, such as noise from an automobile or Shinkansen (Bullet Train) running at a high speed, is proportional to the sixth power of a speed. The third term indicates that noise caused by nonsteady motion of disturbance, such as jet sound of a jet engine, is generated in proportion to the eighth power of a speed.

FIG. 31 represents a result of measuring noise when a car passes a narrow part while changing a running speed, with respect to low to high speed elevators. The horizontal axis represents moving speeds of cars, and the vertical axis represents noise loudness.

Obviously, noise generated when passing a narrow part increases in proportion to the fourth power of a running speed. This implies that noise generated when passing a narrow part is caused by change in volume of airflows due to abrupt influx of air when a top end part of the car is about to pass a narrow part. Therefore, in order to reduce aerodynamic noise at the time when a narrow part is passed, it is considered effective to suppress change in volume of airflows at this time, i.e., to suppress pressure fluctuation.

Even from high speed elevators having a car 31 having a streamlined shape as illustrated in FIGS. 6A and 6B, aerodynamic noise is generated on the same principles as described above.

In a high speed elevator, as has been described referring to FIGS. 7A and 7B, air dammed at a top end part of a rectification cover 32b abruptly flows into the front side of a car 31, thereby generating local accelerated flows. Large pressure fluctuation is caused by the accelerated flows, and aerodynamic noise is generated as a result.

In this case, exciting flows 25 are generated in an ascending direction (during a descent) from an airflow generation device 10b illustrated in FIGS. 6A and 6B, and separation flows formed at the top end part of the rectification cover 32b are thereby suppressed. Accordingly, airflows in front of the car are rectified, and pressure fluctuation can be thereby suppressed.

### Fourteenth Embodiment

Next, the fourteenth embodiment of the present invention will be described.

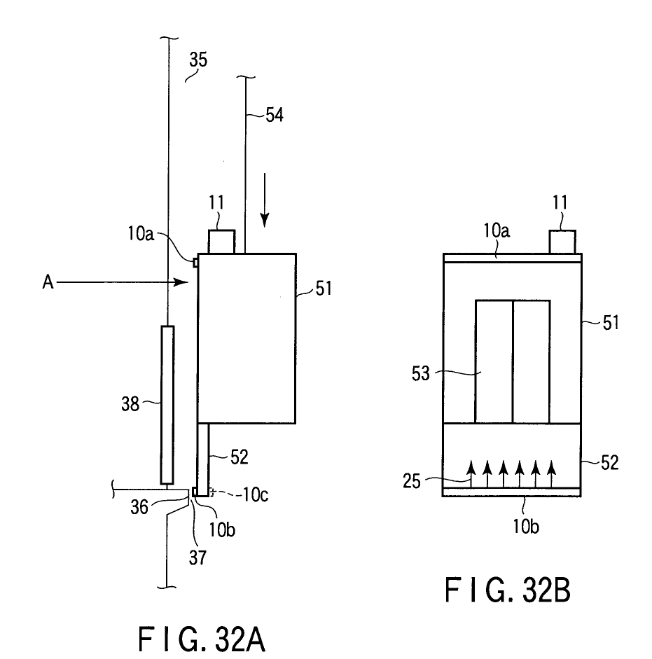

FIGS. 32A and 32B are views illustrating a configuration of an elevator according to the fourteenth embodiment of the invention. FIG. 32A is a side view of a car running in an elevation path. FIG. 32B is a front view of the car observed in a direction A. Components which are common to FIGS. 20A and 20B in the foregoing tenth embodiment will be denoted at common reference symbols, and descriptions thereof will be omitted herefrom.

The present embodiment differs from the tenth embodiment in areas where airflow generation devices are provided. That is, according to the fourteenth embodiment, an airflow generation device 10a is set on a top end part of a box-shaped car 51, so as to lie laterally and cover the top end part entirely in widthwise directions thereof. Similarly, an airflow generation device 10b is set on a top end part of a fall guard plate 52 attached to a lower end part of the car 51, so as to lie laterally and cover the top end part entirely in widthwise directions thereof.

The term of “lie laterally” is intended to mean a state that, where the airflow generation devices 10a and 10b each have a rectangular parallelepiped shape, a lengthwise direction of each of bodies of the devices is arranged in a direction perpendicular to ascending and descending directions, and a generation direction of airflows is oriented in the ascending and descending directions.

The airflow generation devices 10a and 10b each have a configuration as illustrated in FIG. 1 or 3, and are driven at predetermined timings by a drive device 11 during running of the car 31.

The predetermined timings are, specifically, when the upper end part of the car 51 passes each hall sill 36 during an ascent of the car 51 and when the top end part of the fall guard plate 52 passes each hall sill 36 during a descent of the car 51. In this case, the airflow generation device 10a is a target to be driven during an ascent of the car 51, and the airflow generation device 10b is a target to be driven during a descent of the car 51.

Jet ranges of exciting flows 25 spread by thus providing the airflow generation devices 10a and 10b so as to cover the car 51 and the fall guard plate 52 entirely in the widthwise directions, respectively. Accordingly, airflows flowing into the front side of the car can be rectified more effectively, and aerodynamic noise can be thereby reduced.

### Fifteenth Embodiment

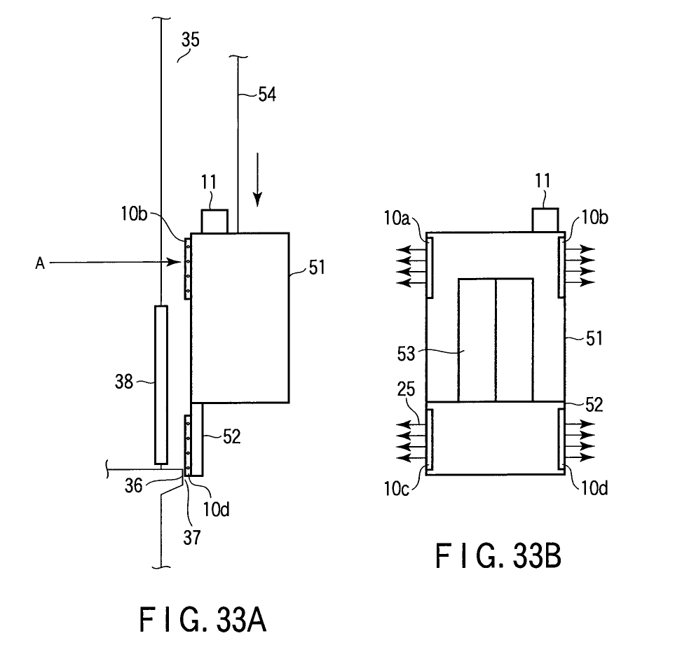

FIGS. 33A and 33B are views illustrating a configuration of an elevator according to the fifteenth embodiment of the invention. FIG. 33A is a side view of a car running in an elevation path. FIG. 33B is a front view of the car observed in a direction A. Components which are common to FIGS. 20A and 20B in the foregoing tenth embodiment will be denoted at common reference symbols, and descriptions thereof will be omitted herefrom.

The present embodiment differs from the tenth embodiment in locations where airflow generation devices are provided. That is, according to the fifteenth embodiment, airflow generation devices 10a and 10b are respectively provided on two sides of an upper end part of a box-shaped car 51, in a manner that the airflow generation devices 10a and 10b stand longitudinally so as to jet exciting flows 25 toward outside of the car 51.

Similarly, airflow generation devices 10c and 10d are respectively provided on two sides of a lower end part of a fall guard plate 52 attached to the car 51, in a manner that the airflow generation devices 10a and 10b longitudinally stand so as to jet exciting flows 25 toward outside of the car 51.

The term of “longitudinally stand” is intended to mean a state that, where the airflow generation devices 10a and 10b as well as the airflow generation devices 10c and 10d each have a rectangular parallelepiped shape, lengthwise directions of each of bodies of these devices are arranged in ascending and descending directions, and generation of airflows is oriented in a direction perpendicular to the ascending and descending directions.

The airflow generation devices 10a to 10d each have a configuration as illustrated in FIG. 1 or 3, and are driven at predetermined timings during running of the car 51.

The predetermined timings are, specifically, when a top end part of the car 51 passes each hall sill 36 during an ascent of the car 51 and when a top end part of the fall guard plate 52 passes each hall sill 36 during a descent of the car 51. In this case, the airflow generation devices 10a and 10b are targets to be driven during an ascent of the car 51, and the airflow generation devices 10b and 10d are targets to be driven during a descent.

Thus, if the airflow generation devices 10a to 10d are provided on two sides of each of the car 51 and the fall guard plate 52 and are each caused to generate outward exciting flows 25, influence of influx from two sides of each of the car 51 and the fall guard plate 52 can be reduced when passing narrow parts 37, and airflows can be thereby rectified in front of the car. As a result, abrupt pressure fluctuation is suppressed, and aerodynamic noise can be suppressed accordingly.

### Sixteenth Embodiment

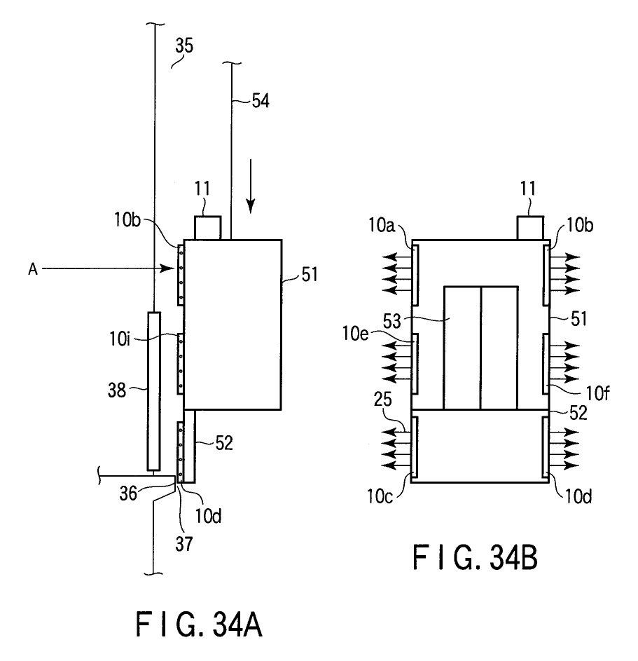

FIGS. 34A and 34B are views illustrating a configuration of an elevator according to the sixteenth embodiment of the invention. FIG. 34A is a side view of a car running in an elevation path. FIG. 34B is a front view of the car from a direction A. Components which are common to FIGS. 20A and 20B in the foregoing tenth embodiment will be denoted at common reference symbols, and descriptions thereof will be omitted herefrom.

The present embodiment differs from the tenth embodiment in locations where airflow generation devices are provided. That is, according to the sixteenth embodiment, airflow generation devices 10a and 10b as well as airflow generation devices 10e and 10f are respectively provided on two sides of a box-shaped car 51 in a manner that the airflow generation devices 10a and 10b as well as 10e and 10f stand longitudinally so as to jet exciting flows 25 toward outside of the car 51.

Similarly, airflow generation devices 10c and 10d are respectively provided on two sides of a lower end part of a fall guard plate 52 attached to the car 51, so that the airflow generation devices 10a and 10b longitudinally stand so as to jet exciting flows 25 toward outside of the car 51.

The term of “longitudinally stand” is intended to mean a state that, where the airflow generation devices 10a and 10b, 10c and 10d, as well as 10e and 10f each have a rectangular parallelepiped shape, lengthwise directions of each of bodies of these devices are arranged in ascending and descending directions, and generation of airflows is oriented in a direction perpendicular to the ascending and descending directions.

The airflow generation devices 10a to 10f each have a configuration as illustrated in FIG. 1 or 3, and are driven at predetermined timings by a drive device 11 during running of the car 31.

The predetermined timings are, specifically, when a top end part of the car 51 passes each hall sill 36 during an ascent of the car 51 and when a top end part of the fall guard plate 52 passes each hall sill 36 during a descent of the car 51. In this case, the airflow generation devices 10a and 10b are targets to be driven during an ascent of the car 51, and the airflow generation devices 10b and 10d are targets to be driven during a descent.

The airflow generation devices 10e and 10f are used during both an ascent and a descent. Accordingly, the airflow generation devices 10a and 10b and the airflow generation devices 10e and 10f are driven during an ascent. The airflow generation devices 10c and 10d and the airflow generation devices 10e and 10f are driven during a descent.

Thus, if the airflow generation devices 10a to 10f are provided along ascending and descending directions on two sides of each of the car 51 and the fall guard plate 52 and are each caused to generate outward exciting flows 25, influence of influx from two sides of each of the car 51 and the fall guard plate 52 can be reduced when passing narrow parts 37, and airflows can be thereby rectified in front of the car. As a result, abrupt pressure fluctuation is suppressed, and aerodynamic noise can be suppressed accordingly.

Further, if the airflow generation devices 10e and 10f provided at intermediate positions are used during both an ascent and a descent, influx from two sides of each of the car 51 and the fall guard plate 52 can be effectively prevented. Therefore, effect of reducing aerodynamic noise can be improved.

Alternatively, the configurations illustrated in FIGS. 32B and 33B may be combined so as to arrange airflow generation devices in a rectangular U-shaped layout on each of top ends of the car 51 and the fall guard plate 52. Exciting flows 25 may then be generated in two directions, i.e., an ascending or descending direction and a direction perpendicular to the ascending or descending direction.

Still alternatively, airflow generation devices may be provided on a counter weight not illustrated.

Still alternatively, airflow generation devices may be provided on a car 31 having a streamlined shape as illustrated in FIGS. 6A and 6B.

The foregoing fourteenth to sixteenth embodiments have been described assuming airflow generation devices using discharge plasma. However, synthetic jet devices described in the foregoing eleventh embodiment and a fan described in the foregoing twelfth embodiment are applicable, as airflow generation devices, to these embodiments in the same manner as described above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An elevator comprising:
a car that ascends and descends in an elevation path; and
at least one airflow generation device that is set on a surface of a top end part of at least one of upper and lower end parts of the car, the surface facing a platform of the elevation path, and suppresses a separation flow generated at the top end of the car during running, thereby to generate an airflow for rectifying an airflow flowing into a front side of the car.

2. The elevator according to claim 1, further comprising:
a position detection unit that detects a position of the car;
a control unit that controls, on the basis of the position detected by the position detection unit, the at least one airflow generation device to be driven at a timing when the top end part of the car passes a hall sill in the elevation path; and
a drive unit that supplies electric power to the at least one airflow generation device, on the basis of a drive signal output from the control unit.

3. The elevator according to claim 1, further comprising a rectification cover that covers the upper and lower end parts of the car, wherein
the at least one airflow generation device is provided on a surface of a top end part of the rectification cover, the surface facing the platform of the elevation path.

4. The elevator according to claim 1, further comprising:
a rectification cover that covers the upper and lower end parts of the car; and
a rectification spoiler that is provided on and protruded from a top end part of the rectification cover, wherein
the at least one airflow generation device is provided on a surface of a top end part of at least one of the rectification cover and the rectification spoiler, the surface facing the platform of the elevation path.

5. The elevator according to claim 1, wherein the at least one airflow generation device is provided in a plurality, arranged tandem along ascending and descending directions of the car.

6. The elevator according to claim 1, wherein the at least one airflow generation device is provided tilted relative to ascending and descending directions of the car.

7. The elevator according to claim 1, further comprising a fall guard plate protruded in a descending direction from an edge of a door at the lower end part of the car, wherein
the at least one airflow generation device is set on a surface of the fall guard plate, the surface facing the platform of the elevation path.

8. The elevator according to claim 1, further comprising a fall guard plate protruded in a descending direction from an edge of a door at the lower end part of the car, wherein
the at least one airflow generation device is set both on a surface of the fall guard plate, the surface facing the platform of the elevation path, and on another surface of the fall guard plate which is opposite to the former surface of the fall guard plate.

9. The elevator according to claim 1, wherein the at least one airflow generation device generates an airflow by an effect of discharge plasma.

10. An elevator comprising:
a car that ascends and descends in an elevation path;
a counter weight that ascends and descends like a draw bucket in association with the car; and
at least one airflow generation device that is set on a top end part of at least one of upper and lower end parts of the counter weight, in a side of the top end part facing the car, and suppresses a separation flow generated at the top end of the counter weight during running, thereby to generate an airflow for rectifying an airflow flowing into a front side of the counter weight.

11. The elevator according to claim 10, further comprising:
a position detection unit that detects a position of the car;
a control unit that controls, on the basis of the position detected by the position detection unit, the at least one airflow generation device to be driven at a timing when the top end part of the counter weight passes the car; and
a drive unit that supplies electric power to the at least one airflow generation device, based on a drive signal output from the control unit.

12. The elevator according to claim 10, wherein the at least one airflow generation device is provided in a plurality, arranged tandem along ascending and descending directions of the counter weight.

13. The elevator according to claim 10, wherein the at least one airflow generation device is provided tilted relative to ascending and descending directions of the counter weight.

14. The elevator according to claim 10, wherein the at least one airflow generation device generates an airflow by an effect of discharge plasma.

15. An elevator comprising:
a car that ascends and descends in an elevation path;
a counter weight that ascends and descends like a draw bucket in association with the car;
at least one first airflow generation device that is set on a surface of a top end part of at least one of upper and lower end parts of the car, the surface facing a platform of the elevation path, and suppresses a separation flow generated at the top end of the car during running, thereby to generate an airflow for rectifying an airflow flowing into a front side of the car; and
at least one second airflow generation device that is set on a top end part of at least one of upper and lower end parts of the counter weight, in a side facing the car, and suppresses a separation flow generated at the top end part of the counter weight during running, thereby to generate an airflow for rectifying an airflow flowing into a front side of the counter weight.

16. The elevator according to claim 15, further comprising:
a position detection unit that detects a position of the car;
a first control unit that controls, on the basis of the position detected by the position detection unit, the at least one first airflow generation device to be driven at a timing when the top end part of the car passes a hall sill in the elevation path;
a first drive unit that supplies electric power to the at least one first airflow generation device, based on a drive signal output from the first control unit;
a second control unit that controls, on the basis of the position detected by the position detection unit, the at least one second airflow generation device to be driven at a timing when the top end part of the counter weight passes the car; and
a second drive unit that supplies electric power to the at least one second airflow generation device, based on a drive signal output from the control unit.

17. The elevator according to claim 15, wherein the at least one airflow generation device generates an airflow by an effect of a discharge plasma.
